(19) United States
(12) Patent Application Publication
(10) Pub. No.: US 2024/0330362 A1
(43) Pub. Date: Oct. 3, 2024

(54) SYSTEM AND METHOD FOR GENERATING VISUAL CAPTIONS

(71) Applicant: GOOGLE LLC, Mountain View, CA (US)

(72) Inventors: Ruofei Du, San Francisco, CA (US); Alex Olwal, Santa Cruz, CA (US); Xingyu Liu, Los Angeles, CA (US)

(21) Appl. No.: 18/555,814

(22) PCT Filed: Oct. 25, 2022
(86) PCT No.: PCT/US2022/078654

§ 371 Date: Oct. 17, 2023

(51) Int. Cl. G06F 16/58; G02B 27/01; G10L 15/26

(52) U.S. Cl. CPC G06F 16/58; G02B 27/017; G10L 15/26; G02B 2027/0178

(57) ABSTRACT

Methods and devices are provided where a device may receive audio data via a sensor of a computing device. The device may convert the audio data to text and extract a portion of the text. The device may input the portion of the text to a neural network-based language model to obtain at least one of a type of visual images, a source of the visual images, a content of the visual images, or a confidence score for the visual images. The device may determine at least one visual image based on at least one of the type of the visual images, the source of the visual images, the content of the visual images, or the confidence score for each of the visual images. The at least one visual image may be output on a display of the computing device to supplement the audio data and facilitate a communication.

### FIELD

This description generally relates to methods, devices, and algorithms used to generate visual captions for speech.

### BACKGROUND

Communication, including both verbal and non-verbal ways, may happen in a variety of formats, such as face-to-face conversations, person-to person remote conversations, video conferences, presentations, listening to audio and video content, or other forms of internet-based communication. Recent advances in capabilities such as live captioning and noise cancellation help improve communication. Voice alone, however, may be insufficient to convey complex, nuanced, or unfamiliar information through verbal communication in these different formats. To enhance communication, people use visual aids such as a quick online image search, sketches, or even hand gestures to provide additional context and nuanced clarification. For example, when “Impression, soleil levant,” or “Claude Monet” is mentioned during a museum tour, a person may not be familiar with the concept being described and may be hesitant to interrupt the tour guide for questioning. Providing visual aids to supplement the speech during the tour may assist in clarifying the unclear concepts and improving communication.

### SUMMARY

Users of computing devices, such as, wearable computing devices such as smart glasses, handheld computing devices such as smartphones, and desktop computing devices such as a personal computer, laptop, or other display devices may use the computing devices to provide real-time visual content to supplement verbal descriptions and to enrich interpersonal communications. One or more language models may be connected to the computing device and may be tuned (or trained) to identify the phrase(s) in the verbal descriptions and the interpersonal communications that are to be visualized at the computing device based on the context of their use. In some examples, images corresponding to these phrases may be selectively displayed at the computing devices to facilitate communication and help people understand each other better.

In some examples, methods and devices may provide visual content for remote communication methods and devices, such as for video conferencing, and for person-to-person communication methods and devices, such as for head-mounted displays, while people are engaged in the communication, i.e., speaking. In some examples, the methods and devices may provide visual content for a continuous stream of human conversation based on intent of the communication and what participants of the communication may want to display in a context. In some examples, the methods and devices may provide visual content subtly so as not to disturb the conversation. In some examples, the methods and devices may selectively add visual content to supplement the communication, may auto-suggest visual content to supplement the communication, and/or may suggest visual content when prompted by a participant of the communication. In some examples, the methods and devices may enhance video conferencing solutions by showing real-time visuals based on the context of what is being spoken and may assist in the comprehension of complex or unfamiliar concepts.

In one general aspect, there is provided a computer-implemented method, including receiving audio data via a sensor of a computing device, converting the audio data to a text and extracting a portion of the text, inputting the portion of the text to a neural network-based language model to obtain at least one of a type of visual images, a source of the visual images, a content of the visual images, or a confidence score for each of the visual images, determining at least one visual image based on at least one of the type of the visual images, the source of the visual images, the content of the visual images, or the confidence score for each of the visual images, and outputting the at least one visual image on a display of the computing device.

In one general aspect, there is provided a computing device, including at least one processor, and a memory storing instructions that, when executed by the at least one processor, configures the at least one processor to: receive audio data via a sensor of the computing device, convert the audio data to a text and extract a portion of the text, input the portion of the text to a neural network-based language model to obtain at least one of a type of visual images, a source of the visual images, a content of the visual images, or a confidence score for each of the visual images, determine at least one visual image based on the type of the visual images, the source of the visual images, the content of the visual images, or the confidence score for each of the visual images, and output the at least one visual image on a display of the computing device. Another example is a system comprising the computing device and the neural network-based language model.

In one general aspect, there is provided a computer-implemented method for providing visual captions, the method including receiving audio data via a sensor of a computing device, converting the audio data to text and extracting a portion of the text, inputting the portion of the text to one or more machine language (ML) models to obtain at least one of a type of visual images, a source of the visual images, a content of the visual images, or a confidence score for each of the visual images from respective ML model of the one or more ML Models, determining at least one visual image by inputting at least one of the type of the visual images, the source of the visual images, the content of the visual images, and the confidence score for each of the visual images to another ML model, and outputting the at least one visual image on a display of the computing device.

The details of one or more implementations are set forth in the accompanying drawings and the description below. Other features will be apparent from the description and drawings, and from the claims.

### BRIEF DESCRIPTION OF THE DRAWINGS

FIG. 1A is an example of a providing visual captions in the field of view of a wearable computing device, according to implementations described throughout this disclosure.

FIG. 1B is an example of a providing visual captions on a display for a video conference, according to implementations described throughout this disclosure.

FIG. 2A illustrates an example system, in accordance with implementations described herein.

FIGS. 2B-2F illustrate example computing devices that can be used in the example system shown in FIGS. 1A-1B and FIGS. 4-9B.

FIG. 3 is a diagram illustrating an example system configured to implement the concepts described herein.

FIG. 4 is a diagram illustrating an examples of a method for providing visual captions, in accordance with implementations described herein.

FIG. 5 is a diagram illustrating an examples of a method for providing visual captions, in accordance with implementations described herein.

FIG. 6 is a diagram illustrating an examples of a method for providing visual captions, in accordance with implementations described herein.

FIG. 7 is a diagram illustrating an example of a method for selecting a portion of the transcribed text in accordance with implementations described herein.

FIG. 8 is a diagram illustrating an example of a method for visualizing the visual captions or images that are to be displayed in accordance with implementations described herein

FIGS. 9A-9B are diagrams illustrating example options for the selection, determination, and display of visual images (captions) to enhance person-to-person communication, video conferencing, podcast, presentation, or other forms of internet-based communication in accordance with implementations described herein.

FIG. 10 is a diagram illustrating an example process flow for providing visual captions, in accordance with implementations described herein.

FIG. 11 is a diagram illustrating an example process flow for providing visual captions, in accordance with implementations described herein.

### DETAILED DESCRIPTION

Users of computing devices, such as, wearable computing devices such as smart glasses, handheld computing devices such as smartphones, and desktop computing devices such as a personal computer, laptop, or other display devices may use the computing devices to provide real-time visual content to supplement verbal descriptions and to enrich interpersonal communications. One or more language models may be connected to the computing device and may be tuned (or trained) to identify the phrase(s) in the verbal descriptions and the interpersonal communications that are to be visualized at the computing device based on the context of their use. In some examples, images corresponding to these phrases may be selectively displayed at the computing devices to facilitate communication and help people understand each other better.

Disclosed are real-time systems and methods for providing visual captions, which are integrated into person-to-person communication, video conference or presentation platform to enrich verbal communication. Visual captions predict the visual intent, or what visual images people would want to show while participating in a conversation and suggest relevant visual content for users to immediately select and display. For example, when a conversation includes speech stating that “Tokyo is located in the Kanto region of Japan,” the system and methods disclosed herein may provide a visual image (caption) in the form of a map of the Kanto region in Japan, which is relevant to the context of the conversation.

Visual augmentations (captions) of spoken language can either be used by the speaker to express their ideas (visualize their own speech) or by the listener to understand others' ideas (visualize others' speech). Disclosed are real-time systems and methods for providing visual captions that permit parties in a communication to use visualizations to understand the speaker's ideas, and to facilitate the user to visually supplement their own speech and ideas. The systems and methods for generating visual captions may be used in various communicative scenarios, including one-on-one meetings, one-to-many lectures, and many-to-many discussions and/or meetings. For example, in educational settings, some presentations may not cover everything that the lecturer is talking about. Oftentimes, when a student asks an out-of-scope question or the teacher talks about a new concept that is not covered by the presentation, a real-time system and method for providing visual captions may help visualize the key concepts or unfamiliar words in the conversation with a visual image (caption) that helps in providing effective education.

In another example, the real-time system and method for providing visual captions may enhance casual conversations by bringing up personal photos, visualizing unknown dishes, and instantly fetching movie posters. In another example, a real-time system and method for providing visual captions may open private visual channel in a business meeting that can remind people of unfamiliar faces when their names are called out.

In another example, the real-time system and method for providing visual captions may be a creativity tool that may help people with brainstorming, create initial design drafts, or efficiently generate mind maps. In another example, the real-time system and method for providing visual captions may be useful for storytelling. For example, when speaking about animal characters, the real-time system and method for providing visual captions may show life-size 3D animals in augmented reality displays to enliven the story telling. Further, the real-time system and method for providing visual captions may improve or even enable communication in loud environments.

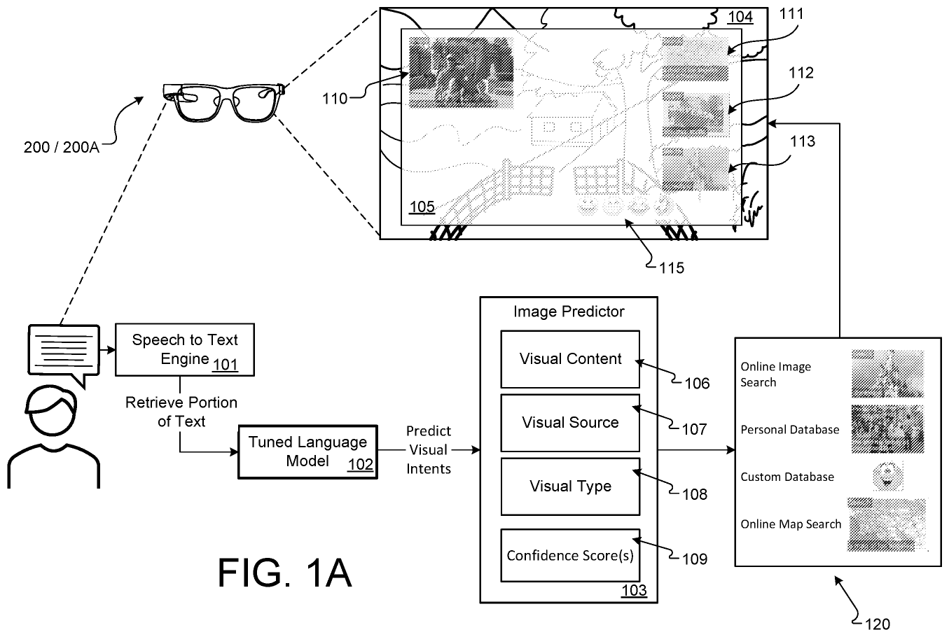

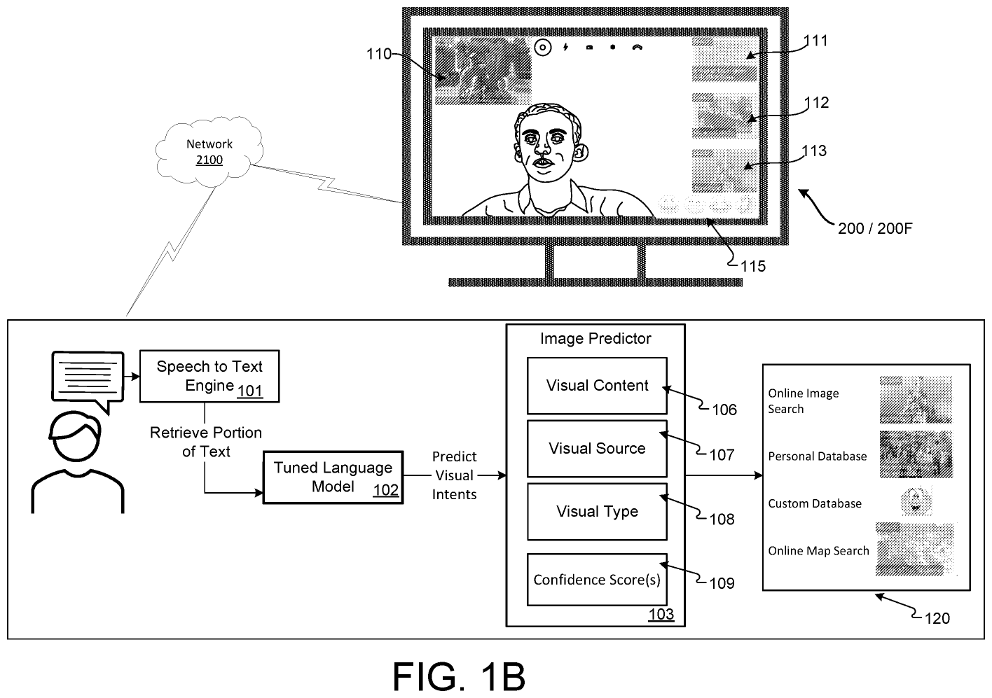

FIG. 1A is an example of providing visual captions in the field of view of a wearable computing device, according to implementations described throughout this disclosure.

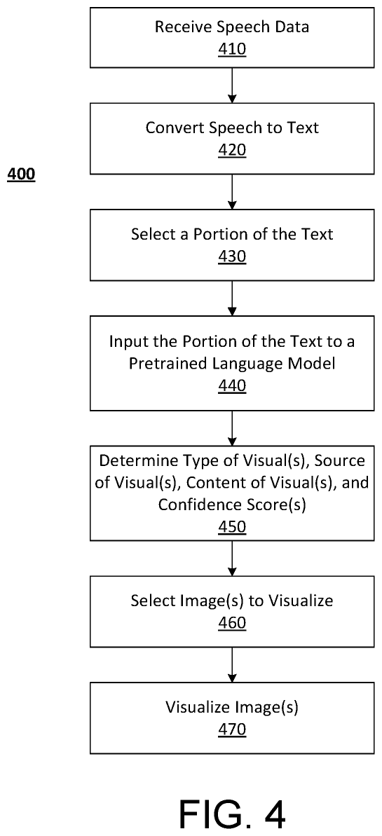

The method and systems of FIG. 1A may be implemented by a computing device having processing, image capture, display capability, and access to information related to the audio data generated during any one or any combination of conversation, video conferencing, and/or presentation. In the example of FIG. 1A, the systems and methods are conducted via a first computing device 200A as described in the examples below, simply for purposes of discussion and illustration. The principles to be described herein can be applied to the use of other types of computing devices for the automated generation and display of real-time image captions, such as for example, computing device 300 (200B, 200C, 200D, 200E, and/or 200F) as described in the examples below, or another computing device having processing and display capability. Description of many of the operations of FIG. 4 are applicable to similar operations of FIG. 1A, thus these descriptions of FIG. 4 are incorporated herein by reference, and may not be repeated for brevity.

As shown in FIG. 1A, at least one processor 350 of the computing device (for example, the first computing device 200A as described in the examples below, or another computing device having processing and image capture capability) may activate one or more audio sensors (for example, a microphone) to capture audio being spoken.

Based on the audio sensor data received, the first computing device 200A may generate textual representation of the speech/voice. In some examples, a microcontroller 355 is configured to generate a textual representation of the speech/voice by executing an application 360 or a ML model 365. In some examples, the first computing device 200A may stream the audio data (e.g., raw sound, compressed sound, sound snippet, extracted features, and/or audio parameters, etc.) to the external resources 390 over the wireless connection 306. In some examples, the transcription engine 101 of the external resources 390 may provide for transcription of the received speech/voice into text.

The at least one processor 350 of the first computing device 200A may extract a portion of the transcribed text.

A portion of the transcribed text is input into a trained language model 102 that identifies image(s) to be displayed on the first computing device 200A. In some examples, the trained language model 102 is executed on a device external to the first computing device 200A. In some examples, the trained language model 102 may accept a text string as an input and output one or more visual intents corresponding to the text string. In some examples, the visual intent corresponds to visual images that participants in a conversation may desire to display, and the visual intent may suggest relevant visual images to be displayed during the conversation, which facilitates and enhances the communication. The trained language model 102 may be optimized to consider the context of the conversation, and to infer a content of the visual images, a source of the visual images that is to be provided, a type of visual images to be provided to the users, and a confidence score for each of the visual images, i.e., the visual content 106, the visual source 107, visual type 108, and the confidence score 109 for each of the visual images.

An image predictor 103 may predict one or more visual images (captions) 120 for visualization based on visual content 106, visual source 107, visual type 108, and confidence scores 109 for the visual images (captions) suggested by the trained language model 102. In some examples, visual content 106, visual source 107, visual type 108, and confidence scores 109 for the visual images (captions) are transmitted from the trained language model 102 to the first computing device 200A. In some examples, the image predictor 103 is a relatively small ML model 365 that is executed on the first computing device 200A, or another computing device having processing and display capability to identify the visual images (captions) 120 to be displayed based on visual content 106, visual source 107, visual type 108, and confidence scores 109 for the visual images (captions) suggested by the trained language model 102.

The at least one processor 350 of the first computing device 200A may visualize the identified visual images (captions) 120.

The identified visual images (captions) 120 may be displayed on an eye box display formed on a virtual screen 104 with a physical world view 105 in the background. In this example, the physical world view 105 is shown for reference, but in operation, the user may be detected to be viewing the content on the virtual screen 104 and thus, the physical world view 105 may be removed from view, blurred, transparent, or other effect may be applied to allow the user to focus on the content depicted on the virtual screen 104.

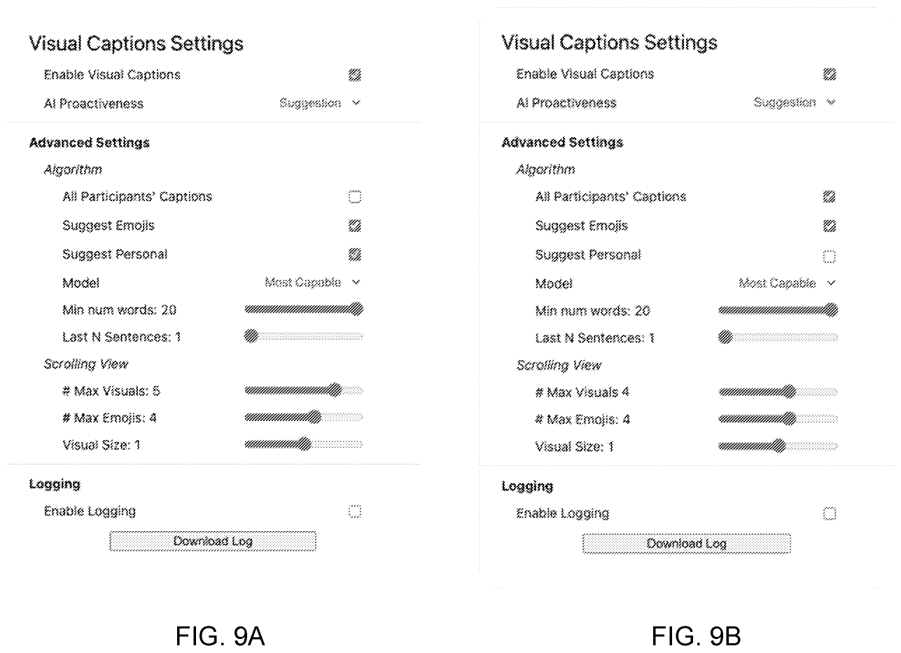

In some examples, the visual images (captions) 111, 112, and 113 are displayed in a vertical scrolling view on the right-hand side of the virtual screen 104. In an example, the visual images (captions) 111, 112, and 113 may be displayed in the vertical scrolling view proximate to a side of the display of the first computing device 200A. The vertical scrolling view may privately display candidates for suggested visual images (captions) that are generated by the trained language model 102 and the image predictor 103. Emojis 115 suggestions are privately displayed on a bottom right corner of the virtual screen 104 in a horizontal scrolling view. In some examples, the horizontal scrolling view of the emojis 115 and the vertical scrolling view of the visual images (captions) 111, 112, and 113 are by default 50% transparent to make them more ambient and less distracting to the main conversation. In some examples, the transparency of the vertical scrolling view and the horizontal scrolling view may be customizable as seen in FIGS. 9A-9B below. In some examples, one or more images or emojis from the vertical scrolling view and the horizontal scrolling view may change to non-transparent based on an input being received from the user.

In some examples, the input from the user may be based on an audio input, a gesture input, a pose input, gaze input that is triggered in response to a gaze being directed at the visual image for greater than or equal to a threshold duration/preset amount of time, traditional input devices (i.e., a controller conferred to recognize keyboard, mouse, touch screens, space bar, and laser pointer), and/or such devices configured to capture and recognize an interaction with the user.

In auto-suggest and on-demand-suggest modes, further described below, where users may approve the visual suggestions, the generated visual images (captions) and emojis are first displayed in a scrolling view. Visual suggestions in the scrolling view are private to the users and not shown to other participants in the conversation. In an example, the scrolling view may automatically be updated when new visual images (captions) are suggested, and the oldest visual images (captions) may be removed if it exceeds the maximum amount of allowed visuals.

To make visual images (captions) or emoji visible for the other participants in the communication, the user may click a suggested visual. In an example, the click may be based on any of the user inputs discussed above. When visual images (captions) and/or an emoji in a scrolling view is clicked, the visual images (captions) and/or the emoji moves to a spotlight view 110. The visual images (captions) and/or the emoji in the spotlight view are visible to the other participants in the communication. The visual images (captions) and/or the emoji in the spotlight view may be moved, resized, and/or deleted.

In an example, when visual images (captions) and/or an emoji are generated in the auto-display mode, further described below, the system autonomously searches and displays visuals publicly to the meeting participants and no user interaction is needed. In auto-display mode, the scrolling view is disabled. In this manner, head mounted computing devices, such as, for example, smart glasses or goggles provides a technical solution to the technical problem presented of enhancing and facilitating communication by displaying visual images (captions) that automatically predict the visual intent, or what visual images people would want to show at the moment of their conversation

FIG. 1B is an example of providing visual captions on a display for a video conference, according to implementations described throughout this disclosure.

The method and systems of FIG. 1B may be implemented by a computing device having processing, image capture, display capability, and access to information related to the audio data generated during any one or any combination of conversation, video conferencing, and/or presentation. In the example of FIG. 1B, the systems and methods are conducted via a sixth computing device 200F as described in the examples below, simply for purposes of discussion and illustration. The principles to be described herein can be applied to the use of other types of computing devices for the automated generation and display of real-time image captions, such as for example, computing device 300 (200A, 200B, 200C, 200D, and/or 200E) as described in the examples below, or another computing device having processing and display capability.

Similar to the display of visual images (captions) and emojis by the first computing device 200A, an example head mounted display device, as illustrated in FIG. 1A, visual images (captions) and emojis may be displayed by sixth computing device 200F, an example smart television, as illustrated in FIG. 1B. Description of many of the operations of FIG. 1A are applicable to similar operations of FIG. 1B for the display of visual images (captions) and emojis during a video conference or a presentation, thus, these descriptions of FIG. 1A are incorporated herein by reference, and may not be repeated for brevity.

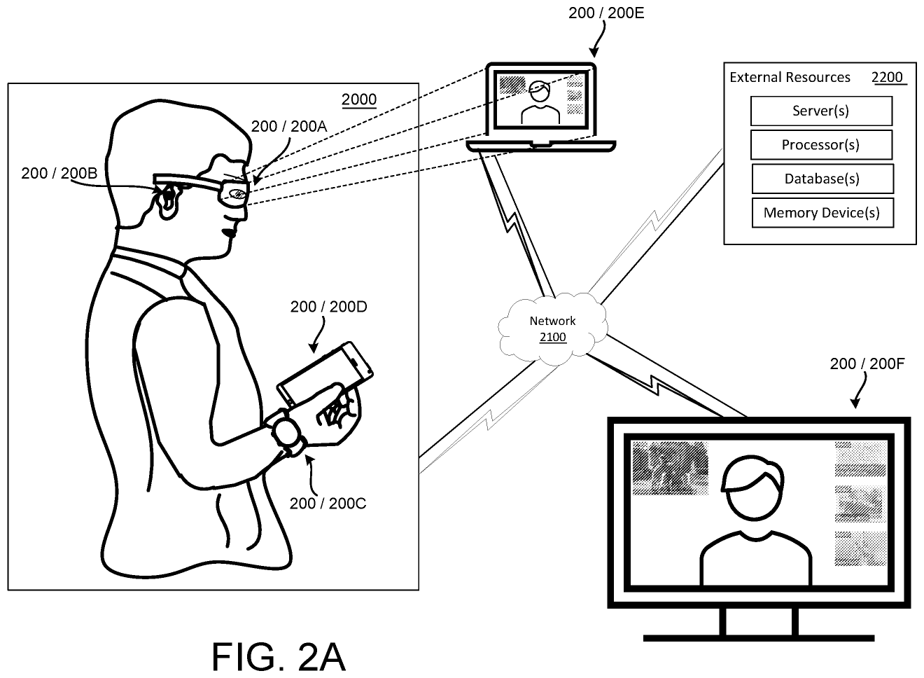

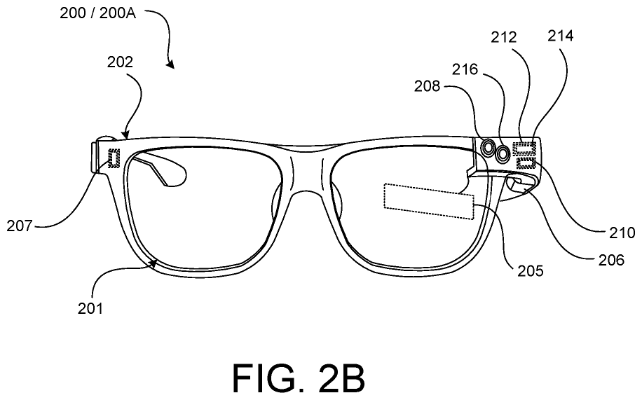

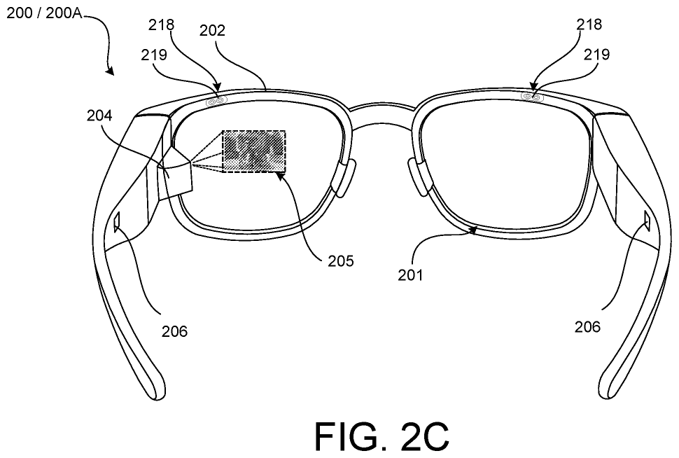

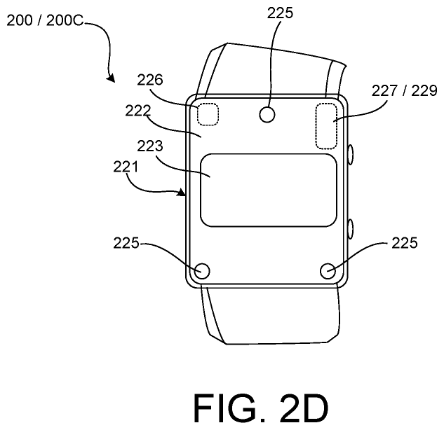

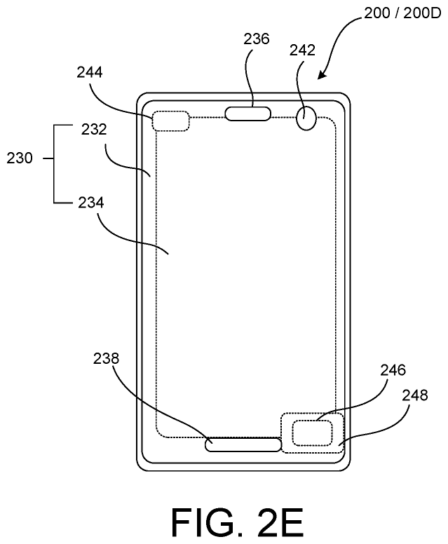

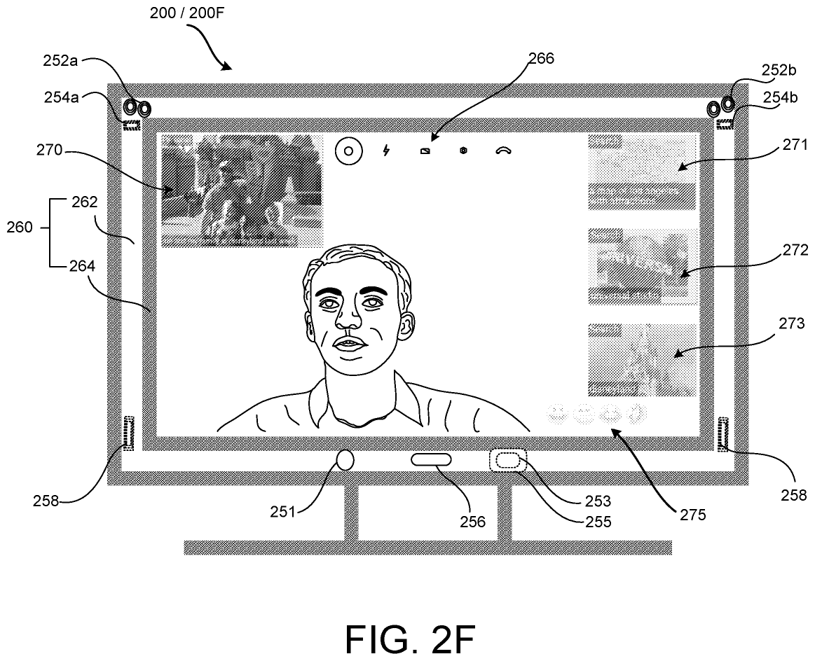

FIG. 2A illustrates an example of the user in a physical environment 2000, with multiple different example computing devices 200 that may be used by the user in the physical environment 2000. The computing devices 200 may include a mobile computing device and may include wearable computing devices and handheld computing devices, as shown in FIG. 2A. The computing devices 200 may include example computing devices, such as 200/200F to facilitate video conferencing or dissemination of information to the user. In the example shown in FIG. 2A, the example computing devices 200 include a first computing device 200A in the form of an example head mounted display (HMD) device, or smart glasses, a second computing device 200B in the form of an example ear worn device, or ear bud(s), a third computing device 200C in the form of an example wrist worn device, or a smart watch, a fourth computing device 200D in the form of an example handheld computing device, or smartphone, a fifth computing device 200E in the form of an example laptop computer or a desktop computer, and a sixth computing device 200F in the form of a television, projections screen, or a display that is configured for person-to-person communication, video conferencing, podcast, presentation, or other forms of internet-based communication. Person-to-person communication, video conference or presentation may be conducted on the fifth computing device 200E using the audio, video, input, output, display, and processing capabilities of the fifth computing device 200E.

Person-to-person communication, video conference or presentation may be conducted on the sixth computing device 200F. The sixth computing device 200F may be connected to any computing device, such as the fourth computing device 200D, the fifth computing device 200E, a projector, another computing device or a server to facilitate the video conferencing. In some examples, the sixth computing device 200F may be a smart display with processing, storage, communication, and control capabilities to conduct the person-to-person communication, video conference or presentation.

The example computing devices 200 shown in FIG. 2A may be connected and/or paired so that they can communicate with, and exchange information with, each other via a network 2100. In some examples, the computing devices 200 may directly communicate with each other through the communication modules of the respective devices. In some examples, the example computing devices 200 shown in FIG. 2A may access external resources 2200 via the network 2100.

FIG. 2B illustrates an example of a front view and FIG. 2C illustrates an example of a rear view of the first computing device 200A in the form of smart glasses. FIG. 2D is a front view of the third computing device in the form of a smart watch. FIG. 2E is a front view of the fourth computing device 200D in the form of a smartphone. 2F is a front view of the sixth computing device 200F in the form of a smart display, television, a smart television, or a projections screen for video conferencing. Hereinafter, example systems and methods will be described with respect to the use of the example computing device 200 in the form of the head mounted wearable computing device shown in FIGS. 2B and 2C, the computing device 200F in the form of a television, a smart television, projections screen, or a display, and/or the handheld computing device in the form of the smartphone shown in FIG. 2E, simply for purposes of discussion and illustration. The principles to be described herein may be applied to other types of mobile computing devices, including the computing devices 200 shown in FIG. 2A, and other computing devices not specifically shown.

As shown in FIGS. 2B and 2C, in some examples, the first computing device 200A is shown as the wearable computing device described herein, other types of computing devices are possible. In some implementations, the wearable computing device 200A includes one or more computing devices, where at least one of the devices is a display device capable of being worn on or in proximity to the skin of a person. In some examples, the wearable computing device 200A is or includes one or more wearable computing device components. In some implementations, the wearable computing device 200A may include a head-mounted display (HMD) device such as an optical head-mounted display (OHMD) device, a transparent heads-up display (HUD) device, a virtual reality (VR) device, an AR device, a smart glass, or other devices such as goggles or headsets having sensors, display, and computing capabilities. In some implementations, the wearable computing device 200A includes AR glasses (e.g., smart glasses). AR glasses represent an optical head-mounted display device designed in the shape of a pair of eyeglasses. In some implementations, the wearable computing device 200A is or includes a piece of jewelry. In some implementations, the wearable computing device 200A is or includes a ring controller device, a piece of jewelry, or other wearable controller.

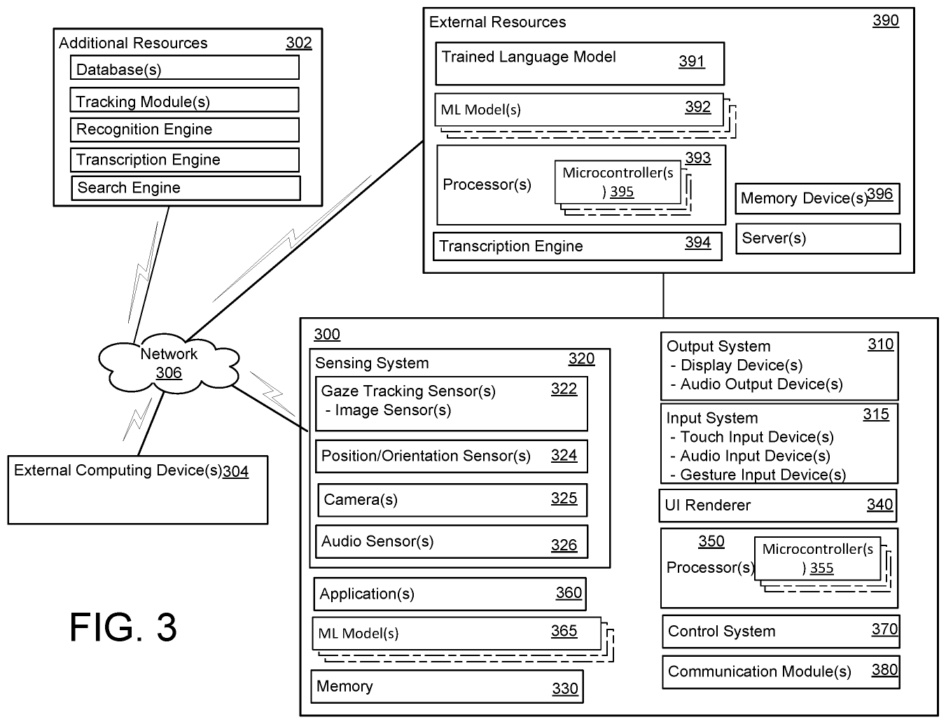

In some examples, the first computing device 200A is a smart glass. In some examples, the smart glasses may superimpose information (e.g., digital images or digital video) onto a field of view through smart optics. Smart glasses are effectively wearable computers which can run self-contained mobile apps (e.g., one or more applications 360 of FIG. 3). In some examples, smart glasses are hands-free and may communicate with the Internet via natural language voice commands, while others may use touch buttons and/or touch sensors unobtrusively disposed in the glasses and/or recognize gestures.

In some examples, the first computing device 200A includes a frame 202 having rim portions surrounding lens portions. In some examples, the frame 202 may include two rim portions connected by a bridge portion. The first computing device 200A includes temple portions that are hingedly attached to two opposing ends of the rim portions. In some examples, a display device 204 is coupled in one or both of the temple portions of the frame 202, to display content to the user within an eye box display 205 formed on the display 201. The eye box display 205 may be varied in size and may be located at different locations of the display 201. In an example, as shown in FIG. 1A more than one eye box display(s) 205 may be formed on the display 201.

In some examples, as shown in FIGS. 1A and 2B-2C, the first computing device 200A adds information (e.g., projects an eye box display 205) alongside what the wearer views through the glasses, i.e., superimposing information (e.g., digital images) onto a field of view of the user. In some examples, the display device 204 may include a see-through near-eye display. For example, the display device 204 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow the user to see both physical items in the world next to digital images (e.g., user interface elements, virtual content, etc.) generated by the display device 204. In some examples, waveguide optics may be used to depict content for output by the display device 204.

FIG. 1A illustrates an example of a display of a wearable computing device 200/200A. FIG. 1A depicts a virtual screen 104 with a physical world view 105 in the background. In some implementations, the virtual screen 104 is not shown while the physical world view 105 is shown. In some implementations, the virtual screen 104 is shown while the physical world view 105 is not shown. In this example, the physical world view 105 is shown for reference, but in operation, the user may be detected to be viewing the content on the virtual screen 104 and thus, the physical world view 105 may be removed from view, blurred, transparent, or other effect may be applied to allow the user to focus on the content depicted on the virtual screen 104.

In some examples, the first computing device 200A can also include an audio output device 206 (for example, one or more speakers), an audio input device 207 (for example, a microphone), an illumination device 208, a sensing system 210, a control system 212, at least one processor 214, and an outward facing imaging sensor 216 (for example, a camera).

In some implementations, the sensing system 210 may also include the audio input device 207 configured to detect audio received by wearable computing device 200/200A. The sensing system 210 may include other types of sensors such as a light sensor, a distance and/or proximity sensor, a contact sensor such as a capacitive sensor, a timer, and/or other sensors and/or different combination(s) of sensors. In some examples, the sensing system 210 may be used to determine the gestures based on a position and/or orientation of limbs, hands, and/or fingers of a user. In some examples, the sensing system 210 may be used to sense and interpret one or more user inputs such as, for example, a tap, a press, a slide, and/or a roll motion on a bridge, rim, template, and/or frame of the first computing device 200A.

In some examples, the sensing system 210 may be used to obtain information associated with a position and/or orientation of the wearable computing device 200/200A. In some implementations, the sensing system 210 also includes or has access to an audio output device 206 (e.g., one or more speakers) that may be triggered to output audio content.

The sensing system 210 may include various sensing devices and the control system 212 may include various control system devices to facilitate operation of the computing devices 200/200A including, for example, at least one processor 214 operably coupled to the components of the control system 212. The wearable computing device 200A includes one or more processors 214/350, which may be formed in a substrate configured to execute one or more machine executable instructions or pieces of software, firmware, or a combination thereof. The one or more processors 214/350 may be semiconductor-based and may include semiconductor material that can perform digital logic. The one or more processor 214/350 may include CPUs, GPUs, and/or DSPs, just to name a few examples.

In some examples, the control system 212 may include a communication module providing for communication and exchange of information between the computing devices 200 and other external devices.

In some examples, the imaging sensor 216 may be an outward facing camera, or a world facing camera that can capture still and/or moving images of external objects in the physical environment within a field of view of the imaging sensor 216. In some examples, the imaging sensor 216 may be a depth camera that can collect data related to distances of the external objects from the imaging sensor 216. In some examples, the illumination device 208 may selectively operate, for example, with the imaging sensor 216, for detection of objects in the field of view of the imaging sensor 216.

In some examples, the computing device 200A includes a gaze tracking device 218 including, for example, one or more image sensors 219. The gaze tracking device 218 may detect and track eye gaze direction and movement. Images captured by the one or more image sensors 219 may be processed to detect and track gaze direction and movement, and to detect gaze fixation. In some examples, identification or recognition operations of the first computing device 200A may be triggered when the gaze directed at the objects/entities has a duration that is greater than or equal to a threshold duration/preset amount of time. In some examples, the detected gaze may define the field of view for displaying images or recognizing gestures. In some examples, user input may be triggered in response to the gaze being fixed on one or more eye box display 205 for more than a threshold period of time. In some examples, the detected gaze may be processed as a user input for interaction with the images that are visible to the user through the lens portions of the first computing device 200A. In some examples, the first computing device 200A may be hands-free and can communicate with the Internet via natural language voice commands, while others may use touch buttons.

FIG. 2D is a front view of the third computing device 200/200C in the form of an example wrist worn device or a smart watch, which is worn on a wrist of a user. The third computing device 200/200C includes an interface device 221. In some examples, the interface device 221 may function as an input device, including, for example, a touch surface 222 that can receive touch inputs from the user. In some examples, the interface device 221 may function as an output device, including, for example, a display portion 223 enabling the interface device 221 to output information to the user. In some examples, the display portion 223 of the interface device 221 may output images to the user to facilitate communication. In some examples, the interface device 221 may receive user input corresponding to one or more images being displayed on the one or more eye box display 205 of the first computing device 200A or on the sixth computing device 200F. In some examples, the interface device 221 can function as an input device and an output device.

The third computing device 200/200C may include a sensing system 226 including various sensing system devices. In some examples, the sensing system 226 may include for example, an accelerometer, a gyroscope, a magnetometer, a Global Positioning System (GPS) sensor, and the like included in an inertial measurement unit (IMU). The sensing system 226 may obtain information associated with a position and/or orientation of wearable computing device 200/200C. The third computing device 200/200C may include a control system 227 including various control system devices and a processor 229 to facilitate operation of the third computing device 200/200C.

In some implementations, the third computing device 200/200C may include a plurality of markers 225. The plurality of markers 225 may be detectable by the first computing device 200/200A, for example, by the outward facing imaging sensor 216 or the one or more image sensors 219 of the first computing device 200/200A, to provide data for the detection and tracking of the position and/or orientation of the third computing device 200/200C relative to the first computing device 200/200A.

FIG. 2E is a front view of the fourth computing device 200/200D in the form of a smart phone held by the user in FIG. 2A. The fourth computing device 200/200D may include an interface device 230. In some implementations, the interface device 230 may function as an output device, including, for example, a display portion 232, allowing the interface device 230 to output information to the user. In some implementations, images may be output on the display portion 232 of the fourth computing device 200/200D. In some implementations, the interface device 230 may function as an input device, including, for example, a touch input portion 234 that can receive, for example, touch inputs from the user. In some implementations, the display portion 232 of the fourth computing device 200/200D may output images to the user to facilitate communication. In some examples, the touch input portion 234 may receive user input corresponding to one or more images being displayed on the one or more eye box display 205 of the first computing device 200A, or on the display portion 232 of the fourth computing device 200/200D or on the sixth computing device 200F. In some implementations, the interface device 230 can function as an input device and an output device. In some implementations, the fourth computing device 200/200D includes an audio output device 236 (for example, a speaker). In some implementations, the fourth computing device 200/200D includes an audio input device 238 (for example, a microphone) that detects audio signals for processing by the fourth computing device 200/200D. In some implementations, the fourth computing device 200/200D includes an image sensor 242 (for example, a camera), that can capture still and/or moving images in the field of view of the image sensor 242. The fourth computing device 200/200D may include a sensing system 244 including various sensing system devices. In some examples, the sensing system 244 may include for example, an accelerometer, a gyroscope, a magnetometer, a Global Positioning System (GPS) sensor and the like included in an inertial measurement unit (IMU). The fourth computing device 200/200D may include a control system 246 including various control system devices and a processor 248, to facilitate operation of the fourth computing device 200/200D.

FIG. 2F illustrates an example of a front view of the sixth computing device 200F/200 in the form of a television, a smart television, projections screen, or a display that is configured for video conferencing, presentation, or other forms of internet-based communication. The sixth computing device 200F may be connected to any computing device, such as the fourth computing device 200D, the fifth computing device 200E, a projector, another computing device, or a server to facilitate the video conferencing or internet-based communication. In some examples, the sixth computing device 200F may be a smart display with processing, storage, communication, and control capabilities to conduct the person-to-person communication, video conference or presentation.

As shown in FIGS. 2A and 2F, the sixth computing device 200F/200 may be a video conferencing endpoint that is interconnected via a network 2100. The network 2100 generally represents any data communications network suitable for the transmission of video and audio data (e.g., the Internet). In some configurations, each of the video conferencing endpoints, sixth computing device 200F/200 includes one or more display devices for displaying the received video and audio data and also includes video and audio capture devices for capturing video and audio data to send to the other video conferencing endpoints. The sixth computing device 200F may be connected to any computing device, such as the fifth computing device 200E, a laptop or desktop computer, a projector, another computing device, or a server to facilitate the video conferencing. In some examples, the sixth computing device may be a smart display with processing, storage, communication, and control capabilities.

The sixth computing device 200F/200 may include an interface device 260. In some implementations, the interface device 260 may function as an output device, including, for example, a display portion 262, allowing the interface device 260 to output information to the user. In some implementations, images 271, 272, 273, and 270 may be output on the display portion 262 of the sixth computing device 200/200F. In some implementations, emojis 275 may be output on the display portion 262 of the sixth computing device 200/200F. In some implementations, the interface device 260 may function as an input device, including, for example, a touch input portion 264 that can receive, for example, touch inputs from the user. In some implementations, the sixth computing device 200/200F may include one or more of an audio input device that can detect user audio inputs, a gesture input device that can detect user gesture inputs (i.e., via image detection, via position detection and the like), a pointer input device that can detect a mouse movement or a laser pointer and/or other such input devices. In some implementations, software-based controls 266 for the sixth computing device 200F/200 may be disposed on the touch input portion 264 of the interface device 260. In some implementations, the interface device 260 can function as an input device and an output device.

In some examples, sixth computing device 200F/200 may include one or more audio output device 258 (for example, one or more speakers), an audio input device 256 (for example, a microphone), an illumination device 254, a sensing system 210, a control system 212, at least one processor 214, and an outward facing imaging sensor 252 (for example, one or more cameras).

Referring to FIG. 2F, the sixth computing device 200F/200 includes the imaging assembly having multiple cameras (e.g., 252a and 252b, collectively referenced as imaging sensor 252) that capture images of the people participating in the video conference from various viewing angles. In some examples, the imaging sensor 252 may be an outward facing camera, or a world facing camera that can capture still and/or moving images of external objects in the physical environment within a field of view of the imaging sensor 252. In some examples, the imaging sensor 252 may be a depth camera that can collect data related to distances of the external objects from the imaging sensor 252. In some examples, the illumination devices (e.g., 254a and 254b, collectively referenced as illumination device 254) may selectively operate, for example, with the imaging sensor 252, for detection of objects in the field of view of the imaging sensor 252.

In some examples, the sixth computing device 200F may include a gaze tracking device including, for example, the one or more imaging sensor 252. In some examples, the gaze tracking device may detect and track eye gaze direction and movement of the viewer of the display portion 262 of the sixth computing device 200/200F. In some examples, the gaze tracking device may detect and track eye gaze direction and movement of participants in a meeting or video conference.

Images captured by the one or more imaging sensor 252 may be processed to detect gaze fixation. In some examples, the detected gaze may be processed as a user input for interaction with the images 271, 272, 273, and 270 and/or emoji 275 that are visible to the user through the display portion 262 of the sixth computing device 200F. In some examples, based on user input, any one or more of the images 271, 272, 273, and 270 and/or emoji 275 may be shared with the participants of a one-to-one communication, meeting, video conferencing, and/or presentation when the gaze directed at the objects/entities has a duration that is greater than or equal to a threshold duration/preset amount of time. In some examples, the detected gaze may define the field of view for displaying images or recognizing gestures.

In some examples, the sixth computing device 200F/200 may include a sensing system 251 including various sensing system devices. In some examples, the sensing system 251 may include other types of sensors such as a light sensor, a distance and/or proximity sensor, a contact sensor such as a capacitive sensor, a timer, and/or other sensors and/or different combination(s) of sensors. In some examples, the sensing system 251 may be used to determine the gestures based on a position and/or orientation of limbs, hands, and/or fingers of a user. In some examples, the sensing system 251 may be used to obtain information associated with a position and/or orientation of the wearable computing device 200/200A and or 200/200C. In some examples, the sensing system 251 may include, for example, a magnetometer, a Global Positioning System (GPS) sensor and the like. In some implementations, the sensing system 251 also includes or has access to an audio output device 258 (e.g., one or more speakers) that may be triggered to output audio content.

The sixth computing device 200F/200 may include a control system 255 including various control system devices and one or more processors 253, to facilitate operation of the sixth computing device 200F/200. The one or more processors 253 may be formed in a substrate configured to execute one or more machine executable instructions or pieces of software, firmware, or a combination thereof. The one or more processors 253 may be semiconductor-based and may include semiconductor material that can perform digital logic. The one or more processors 253 may include CPUs, GPUs, and/or DSPs, just to name a few examples.

In some examples, the one or more processors 253 controls the imaging sensor 252 to select one of the cameras to capture images of people who have spoken within a predetermined period of time. The one or more processors 253 may adjust the viewing direction and zoom factor of the selected camera so that images captured by the selected camera show most or all of the people actively participating in the discussion.

In some examples, the control system 255 may include a communication module providing for communication and exchange of information between the computing devices 200 and other external devices.

FIG. 3 is a diagram illustrating an example of a system including an example computing device 300. In the example system shown in FIG. 3, the example computing device 300 may be, for example, one of the example computing devices 200 (200A, 200B, 200C, 200D, 200E, and/or 200F) shown in FIG. 2A and described in more detail with respect to FIGS. 2A-2F. The example computing device 300 may be another type of computing device not specifically described above, that can detect user input, provide a display, output content to the user, and other such functionality to be operable in the disclosed systems and methods.

In the example arrangement shown in FIG. 3, the computing device 300 can communicate selectively via a wireless connection 306 to access any one or any combination of external resources 390, one or more external computing device(s) 304, and additional resources 302. The external resources 390 may include, for example, server computer systems, trained language model 391, Machine Learning (ML) models 392, processors 393, transcription engine 394, databases, memory storage, and the like. The computing device 300 may operate under the control of a control system 370. The control system 370 may be configured to generate various control signals and communicate the control signals to various blocks in the computing device 300. The control system 370 may be configured to generate the control signals to implement the techniques described herein. The control system 370 may be configured to control the processor 350 to execute software code to perform a computer-based process. For example, the control system 370 may generate control signals corresponding to parameters to implement a search, control an application, store data, execute an ML model, train an ML model, communicate with and access external resources 390, additional resources 302, external computing devices(s) 304, and/or the like.

The computing device 300 may communicate with one or more external computing devices 304 (a wearable computing device, a mobile computing device, a computing device, a display, an external controllable device, and the like) either directly (via wired and/or wireless communication), or via the wireless connection 306. The computing device 300 may include a communication module 380 to facilitate external communication. In some implementations, the computing device 300 includes a sensing system 320 including various sensing system components including, for example one or more gaze tracking sensors 322 including, for example image sensors, one or more position/orientation sensor(s) 324 including for example, accelerometer, gyroscope, magnetometer, Global Positioning System (GPS) and the like included in an IMU, one or more audio sensors 326 that can detect audio input, and one or more camera(s) 325.

In some examples, the computing device 300 may include one or more camera(s) 325. The camera(s) 325 may be, for example, outward facing, or world facing cameras that can capture still and/or moving images of an environment outside of the computing device 300. The computing device 300 can include more, or fewer, sensing devices and/or combinations of sensing devices.

In some examples, the computing device 300 may include an output system 310 including, for example, one or more display devices that can display still and/or moving image content and one or more audio output devices that can output audio content. In some implementations, the computing device 300 may include an input system 315 including, for example, one or more touch input devices that can detect user touch inputs, an audio input device that can detect user audio inputs, a gesture input device that can detect user gesture inputs (i.e., via image detection, via position detection and the like), a gaze input that can detect user gaze, and other such input devices. The still and/or moving images captured by the camera(s) 325 may be displayed by the display device of the output system 310 and/or transmitted externally via the communication module 380 and the wireless connection 306, and/or stored in the memory devices 330 of the computing device 300. In some examples, the computing device 300 may include a UI renderer 340 configured to render one or more images on the display device of the output system 310.

The computing device 300 may include one or more processors 350, which may be formed in a substrate configured to execute one or more machine executable instructions or pieces of software, firmware, or a combination thereof. In some examples, the processor(s) 350 are included as part of a system on chip (SOC). The processor(s) 350 may be semiconductor-based that include semiconductor material that can perform digital logic. The processor 350 may include CPUs, GPUs, and/or DSPs, just to name a few examples. The processor(s) 350 may include microcontrollers 355. In some examples, the microcontroller 355 is a subsystem within the SOC and can include a process, memory, and input/output peripherals.

In some examples, the computing device 300 includes one or more applications 360, which can be stored in the memory devices 330, and that, when executed by the processor(s) 350, perform certain operations. The one or more applications 360 may widely vary depending on the use case, but may include browser applications to search web content, sound recognition applications such as speech-to-text applications, text editing applications, image recognition applications (including object and/or facial detection (and tracking) applications, applications for determining of a visual content, applications for applications for determining of a visual type, determining of a visual source, and applications for predicting of a confidence score, etc.), and/or other applications that can enable the computing device 300 to perform certain functions (e.g., capture an image, display an image, share image, record a video, get directions, send a message, etc.). In some examples, the one or more applications 360 may include an email application, a calendar application, a storage application, a voice call application, and/or a messaging application.

In some examples, the microcontroller 355 is configured to execute a machine-learning (ML) model 365 to perform an inference operation related to audio and/or image processing using sensor data. In some examples, the computing device 300 includes multiple microcontrollers 355 and multiple ML models 365 that perform multiple inference operations, which can communicate with each other and/or other devices (e.g., external computing device(s) 304, additional resources 302, and/or external resources 390). In some implementations, the communicable coupling may occur via a wireless connection 306. In some implementations, the communicable coupling may occur directly between computing device 300, external computing device(s) 304, additional resources 302, and/or the external resources 390.

In some implementations, the memory devices 330 may include any type of storage device that stores information in a format that can be read and/or executed by the processor(s) 350. The memory devices 330 may store applications 360 and ML models 365 that, when executed by the processor(s) 350, perform certain operations. In some examples, the applications 360 and ML models 365 may be stored in an external storage device and loaded into the memory devices 330.

In some examples, the audio and/or image processing that is performed on the sensor data obtained by the sensor(s) of the sensing system 320 are referred to as inference operations (or ML inference operations). An inference operation may refer to an audio and/or image processing operation, step, or sub-step that involves a ML model that makes (or leads to) one or more predictions. Certain types of audio, text, and/or image processing use ML models to make predictions. For example, machine learning may use statistical algorithms that learn data from existing data to render a decision about new data, which is a process called inference. In other words, inference refers to the process of taking a model that is already trained and using that trained model to make predictions. Some examples of inference may include sound recognition (e.g., speech-to-text recognition), image recognition (e.g., object identifications, etc.), image recognition (e.g., facial recognition and tracking, etc.), and/or perception (e.g., always-on sensing, voice-input request sensing, etc.). The ML model 365 may define several parameters that are used by the ML model 365 to make an inference or prediction regarding the images that are displayed. In some examples, the number of parameters is in a range between 10 k and 100 k. In some examples, the number of parameters is less than 10 k. In some examples, the number of parameters is in a range between 10 M and 100 M. In some examples, the number of parameters is greater than 100 M.

In some examples, the ML model 365 includes one or more neural networks. Neural networks transform an input, received by the input layer, transform it through a series of hidden layers, and produce an output via the output layer. Each layer is made up of a subset of the set of nodes. The nodes in hidden layers may be fully connected to all nodes in the previous layer and provide their output to all nodes in the next layer. The nodes in a single layer may function independently of each other (i.e., do not share connections). Nodes in the output provide the transformed input to the requesting process. In some examples, the neural network is a convolutional neural network, which is a neural network that is not fully connected. Convolutional neural networks can also make use of pooling or max-pooling to reduce the dimensionality (and hence complexity) of the data that flows through the neural network and thus this can reduce the level of computation required. This makes computation of the output in a convolutional neural network faster than in neural networks.

In some examples, the ML model 365 may be trained by comparing one or more images predicted by the ML model 365 to data indicating the actual desired image. This data indicating the actual desired image is sometimes called the ground-truth. In an example, the training may include comparing the generated bounding boxes to the ground-truth bounding boxes using a loss function. The training can be configured to modify the ML model 365 (also referred to as trained model) used to generate the images based on the results of the comparison (e.g., the output of the loss function).

The trained ML model 365 may then be further developed to perform the desired output function more accurately (e.g., detect or identify an image) based on the input that is received. In some examples, the trained ML model 365 may be used on the input either immediately (e.g., to continue training, or on live data) or in the future (e.g., in a user interface configured to determine user intent or to determine an image to display and/or share). In some examples, the trained ML model 365 may be used on live data, and the result of the inference operation when live data is provided as an input may be used to fine tune the ML model 365 or to minimize the loss function.

In some implementations, the memory devices 330 may include any type of storage device that stores information in a format that can be read and/or executed by the processor(s) 350. The memory devices 330 may store applications 360 and ML models 365 that, when executed by the processor(s) 350, perform certain operations. In some examples, the applications 360 and ML models may be stored in an external storage device and loaded into the memory devices 330.

In some implementations, the computing device 300 may access additional resources 302 to, for example, to facilitate the identification of images corresponding to the texts, to determine visual types corresponding to the speech, to determine visual content corresponding to the speech, to determine visual source corresponding to the speech, to determine confidence score(s) corresponding to the images, to interpret voice commands of the user, to transcribe the speech to text, and the like. In some implementations, the additional resources 302 may be accessible to the computing device 300 via the wireless connection 306 and/or within the external resources 390. In some implementations, the additional resources may be available within the computing device 300. The additional resources 302 may include, for example, one or more databases, one or more ML models, and/or and one or more processing algorithms. In some implementations, the additional resources 302 may include a recognition engine, providing for identification of images corresponding to the text. images to display based on one or more of the visual content, the visual types, the visual source, and the confidence score(s) corresponding to the one or more images

In some implementations, the additional resources 302 may include representation databases including, for example, visual patterns associated with objects, relationships between various objects, and the like. In some implementations, the additional resources may include a search engine to facilitate searching associated with objects and/or entities identified from the speech, obtaining additional information related to the identified objects, and the like. In some implementations, the additional resources may include a transcription engine, providing for transcription of detected audio commands for processing by the control system 370 and/or the processor(s) 350. In some implementations, the additional resources 302 may include a transcription engine, providing for transcription of speech into text.

In some implementations, the external resources 390 may include a trained language model 391, ML model(s) 392, one or more processors 393, transcription engine 394, memory devices 396, and one or more servers. In some examples, the external resources 390 may be disposed on another one of the example computing devices 300 (200A, 200B, 200C, 200D, 200E, and/or 200F), or another type of computing device not specifically described above, that can detect user input, provide a display, process speech to identify appropriate images for captions, output content to the user, and other such functionality to be operable in the disclosed systems and methods.

The one or more processors 393 may be formed in a substrate configured to execute one or more machine executable instructions or pieces of software, firmware, or a combination thereof. In some examples, the processor(s) 393 are included as part of a system on chip (SOC). The processor(s) 393 may be semiconductor-based that include semiconductor material that can perform digital logic. The processor 393 may include CPUs, GPUs, and/or DSPs, just to name a few examples. The processor(s) 393 may include one or more microcontrollers 395. In some examples, the one or more microcontrollers 395 is a subsystem within the SOC and can include a process, memory, and input/output peripherals.

In some examples, the trained language model 391 may accept a text string as an input and output one or more visual intents corresponding to the text string. In some examples, the visual intent corresponds to visual images that participants in a conversation may desire to display, and the visual intent may suggest relevant visual images to be displayed during the conversation, which facilitates and enhances the communication. The trained language model 391 may be optimized to consider the context of the conversation, and to suggest a type of visual images to be provided to the users, a source of the visual images that is to be provided, a content of the visual images, and a confidence score for each of the visual images.

In some examples, the trained language model 391 may be a deep learning model that differentially weights the significance of each part of the input data. In some examples, trained language model 391 may process the entire input text at the same time to provide the visual intents. In some examples, trained language model 391 may process the entire input text of the last complete sentence to provide the visual intents. In some examples, an end of sentence punctuation, such as “.”, “?”, or “!” may signify the sentence being complete. In some examples, trained language model 391 may process the entire input text of the last two complete sentences to provide the visual intents. In some examples, trained language model 391 may process the entire input text of at least the last nₘᵢₙ words to provide the visual intents. In some examples, nmin may be set to 4. In some examples, the portion of the text that is extracted from the input text may include at least a number of words from an end of the text that is greater than a threshold. In some examples, the trained language model 391 may be trained with large datasets to provide accurate inference of visual intents from the speech. The trained language model 391 may define several parameters that are used by the trained language model 391 to make an inference or prediction. In some examples, the number of parameters may be more than 125 million. In some examples, the number of parameters may be more than 1.5 billion. In some examples, the number of parameters may be more than 175 billion.

In some examples, a trained ML model 392 and/or the trained ML model 365 may take the output from the trained language model 391 to identify image(s) to display during the conversation. In some examples, the ML model 392 and/or the trained ML model 365 may be based on a convolutional neural network. In some examples, the ML model 392 and/or the trained ML model 365 may be trained for a plurality of users and/or a single user. In some examples, when the trained ML model 365 is trained for a single user the trained ML model 365 may be disposed only on one or more of the example computing devices 300, such as 200A, 200B, 200C, 200D, 200E, and/or 200F.

In some examples, the ML model 392 and/or the trained ML model 365 may be trained and stored on a network device. In an initialization process, the ML model may be downloaded from the network device to the external resources 390. The ML model may be further trained before use and/or as the ML model is used at the external resources 390. In another example, the ML model 392 may be trained for a single user based on the feedback from the user as the ML model 392 is used to predict images.

In some examples, the one or more microcontrollers 395 are configured to execute one or more machine-learning (ML) model 392 to perform an inference operation, such as determining of a visual content, determining of a visual type, determining of a visual source, predicting of a confidence score, predicting images related to audio and/or image processing using sensor data. In some examples, the processor 393 is configured to execute the trained language model 391 to perform an inference operation, such as determining of a visual content, determining of a visual type, determining of a visual source, predicting of a confidence score, predicting images related to audio and/or image processing using sensor data.

In some examples, the external resources 390 includes multiple microcontrollers 395 and multiple ML models 392 that perform multiple inference operations, which can communicate with each other and/or other devices (e.g., the computing device 300, external computing device(s) 304, additional resources 302, and/or external resources 390). In some implementations, the communicable coupling may occur via a wireless connection 306. In some implementations, the communicable coupling may occur directly between computing device 300, external computing device(s) 304, additional resources 302, and/or the external resources 390.

In some examples, image identification and retrieval operations are distributed between one or more of the example computing devices 300 (200A, 200B, 200C, 200D, 200E, and/or 200F), external resources 390, external computing device(s) 304, and/or additional resources 302. For example, the wearable computing device 200A includes a sound classifier (e.g., a small ML model) configured to detect whether or not a sound of interest (e.g., conversation, presentation, conference, etc.) is included within the audio data captured by a microphone on the wearable device. If a sound of interest is detected and image captions are desired, the computing devices 300 (200A, 200B, 200C, 200D, 200E, and/or 200F) may stream the audio data (e.g., raw sound, compressed sound, sound snippet, extracted features, and/or audio parameters, etc.) to the external resources 390 over the wireless connection 306. If not, the sound classifier continues to monitor the audio data to determine if the sound of interest is detected. The sound classifier may save power and latency through its relatively small ML model. The external resources 390 includes a transcription engine 394 and a more powerful trained language model that identifies image(s) to be displayed on the computing devices 300 (200A, 200B, 200C, 200D, 200E, and/or 200F), and the external resources 390 transmits the data back to the computing devices 300 (200A, 200B, 200C, 200D, 200E, and/or 200F) via the wireless connection for images to be displayed on the display of the computing devices 300 (200A, 200B, 200C, 200D, 200E, and/or 200F).

In some examples, a relatively small ML model 365 is executed on the computing devices 300 (200A, 200B, 200C, 200D, 200E, and/or 200F) to identify the images to be displayed on the display based on visual intents received from the trained language model 391 on the external resources 390. In some examples, the computing device is connected to a server computer over a network (e.g., the Internet), and the computing device transmits the audio data to the server computer, where the server computer executes a trained language model to identify the images to be displayed. Then, the data identifying the images is routed back to the computing devices 300 (200A, 200B, 200C, 200D, 200E, and/or 200F) for display.

In some examples, an application may prompt the user whether image captions are desired when a remote conversation, video conferencing, and/or presentation is commenced on a computing device being used by the user. In some examples, a user may request for the visual captions (images) to be provided to supplement the conversation, meeting, and/or presentation.

In some implementations, the memory devices 396 may include any type of storage device that stores information in a format that can be read and/or executed by the processor(s) 350. The memory devices 396 may store ML models 392 and trained language model 391 that, when executed by the processor(s) 393 or the one or more microcontrollers 395, perform certain operations. In some examples, the ML models may be stored in an external storage device and loaded into the memory devices 396.

FIGS. 4-7 are diagrams illustrating examples of methods for providing visual captions, in accordance with implementations described herein FIG. 4 illustrates operation of a system and method, in accordance with implementations described herein, in which visual captions are provided by any one or any combination of the first computing device 200A to the sixth computing device 200F illustrated in FIGS. 2A-3. In the example shown in FIGS. 4-7, the system and method are conducted by the user via a head mounted wearable computing device in the form of a pair of smart glasses (for example, 200A) or a display device in the form of a smart television (for example, 200F), simply for purposes of discussion and illustration. The principles to be described herein can be applied to the use of other types of computing devices.

FIG. 4 is a diagram illustrating an example of a method 400 for providing visual captions to facilitate a conversation, video conferencing, and/or presentation, in accordance with implementations described herein. The method may be implemented by a computing device having processing, image capture, display capability, and access to information related to the audio data generated during any one or any combination of conversation, video conferencing, and/or presentation. In the example of FIG. 4, the systems and methods are conducted via the first computing device 200A or the sixth computing device 200F as described in the examples above, simply for purposes of discussion and illustration. The principles to be described herein can be applied to the use of other types of computing devices for the automated generation and display of real-time video captions, such as for example, computing device 300 (200B, 200C, 200D, and/or 200E) as described in the examples above, or another computing device having processing and display capability. Although FIG. 4 illustrates an example of operations in sequential order, it will be appreciated that this is merely an example, and that additional or alternative operations may be included. Further, the operations of FIG. 4 and related operations may be executed in a different order than that shown, or in a parallel or overlapping fashion.

In operation 410, at least one processor 350 of the computing device (for example, the first computing device 200A or the sixth computing device 200F as described in the examples above, or another computing device having processing and image capture capability) may activate an audio sensor to capture audio being spoken. In an example, in operation 410, the computing device may receive sensor data from one or more audio input device 207 (for example, a microphone).

In some examples, the first computing device 200A or the sixth computing device 200F as described in the examples above includes a sound classifier (e.g., a small ML model) configured to detect whether or not a sound of interest (e.g., conversation, presentation, conference, etc.) is included within the audio data captured by a microphone on the first computing device 200A or the sixth computing device 200F as described in the examples above. In some examples, if a sound of interest is detected and image captions are desired, the first computing device 200A or the sixth computing device 200F as described in the examples above may stream the audio data (e.g., raw sound, compressed sound, sound snippet, extracted features, and/or audio parameters, etc.) to the external resources 390 over the wireless connection 306. If not, the sound classifier continues to monitor the audio data to determine if the sound of interest is detected.

In some examples, the first computing device 200A may include a voice command detector that executes a ML model 365 to continuously or periodically process microphone samples for a hot-word (e.g., “create visual caption,” “ok G” or “ok D”). In some examples, the at least one processor 350 of the first computing device 200A may be activated to receive and capture the audio when the hot-word is recognized. If the first computing device 200A is activated, the at least one processor 350 may cause a buffer to capture the subsequent audio data and to transmit a portion of the buffer to the external resource 390 over the wireless connection.

In some examples, an application may prompt the user whether image captions are desired when a remote conversation, video conferencing, and/or presentation is commenced on a computing device being used by the user. If an affirmative response is received from the user, the one or more audio input device 207 (for example, a microphone) may be activated to receive and capture the audio. In some examples, a user may request for the visual captions (images) to be provided to supplement the conversation, meeting, and/or presentation. In such examples, the one or more audio input device 207 (for example, a microphone) may be activated to receive and capture the speech.

In operation 420, based on the sensor data received, the computing device (for example, the first computing device 200A or the sixth computing device 200F as described in the examples above, or another computing device having processing and display capability) may convert the speech to text to generate textual representation of the speech/voice. In some examples, a microcontroller 355 is configured to generate a textual representation of the speech/voice by executing an application 360 or a ML model 365. In some examples, the first computing device 200A or the sixth computing device 200F as described in the examples above may stream the audio data (e.g., raw sound, compressed sound, sound snippet, extracted features, and/or audio parameters, etc.) to the external resources 390 over the wireless connection 306. The transcription engine 394 of the external resources 390 may provide for transcription of the received speech/voice into text.

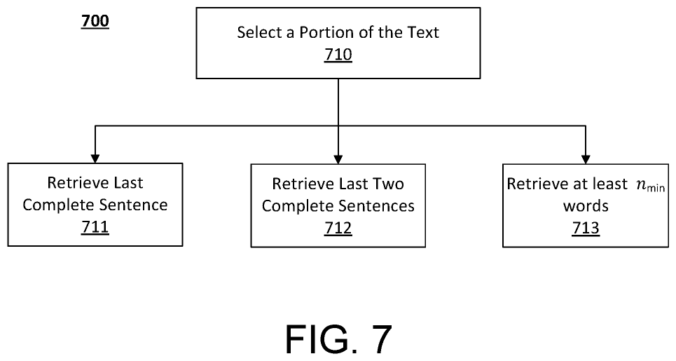

In operation 430, a portion of the transcribed text is selected. The selection of the transcribed text is described further with reference to FIG. 7 below.

In operation 440, a portion of the transcribed text is input into a trained language model that identifies image(s) to be displayed on the computing devices 300 (for example, the first computing device 200A or the sixth computing device 200F as described in the examples above, or another computing device having processing and display capability). In some examples, the trained language model 391 may accept a text string as an input and output one or more visual intents corresponding to the text string. In some examples, the visual intent corresponds to visual images that participants in a conversation may desire to display, and the visual intent may suggest relevant visual images to be displayed during the conversation, which facilitates and enhances the communication. The trained language model 391 may be optimized to consider the context of the conversation, and to infer a type of visual images to be provided to the users, a source of the visual images that is to be provided, a content of the visual images, and a confidence score for each of the visual images.

In some examples, the trained language model 391 may be a deep learning model that differentially weights the significance of each part of the input data. In some examples, trained language model 391 may process the entire input text at the same time to provide the visual intents. In some examples, trained language model 391 may process the entire input text of the last complete sentence to provide the visual intents. In some examples, trained language model 391 may process the entire input text of the last two complete sentences to provide the visual intents. In some examples, trained language model 391 may process the entire input text including at least the last nₘᵢₙ words to provide the visual intents. In some examples, the trained language model 391 may be trained with large datasets to provide accurate inference of visual intents from the real-time speech.

In operation 450, in response to the input text, the trained language model 391 or the trained language model 102 (illustrated in FIGS. 1A-1B) may be optimized (trained) to consider the context of the speech and to predict the user's visual intent. In some examples, the prediction of the user's visual intent may include suggesting visual content 106, visual source 107, visual type 108, and confidence scores 109 for the visual images (captions).

In some examples, the visual content 106 may determine the information that is to be visualized. For example, considering the statement “I went to Disneyland with my family last weekend,” which includes several types of information that may be visualized. For example, the generic term Disneyland may be visualized, or a representation of I may be visualized, or an image or Disneyland may be visualized, or a map of Disneyland may be visualized, or more specific, contextual information such as me and my family at Disneyland may be visualized. The trained language model 391 or the trained language model 102 may be trained to disambiguate the most relevant information to visualize in the current context.

In some examples, the visual source 107 may determine where the visual image (caption) is to be retrieved from, such as, for example, a private photo directory, a public Google search, emoji database, social media, Wikipedia, and or Google image search. In some examples, diverse sources may be utilized for the visual images (captions), including both personal and public resources. For example, when saying “I went to Disneyland last weekend,” one might want to retrieve personal photos from one's own phone, or public images from the internet. While personal photos provide more contextual and specific information, images from the internet can provide more generic and abstract information that can be applied to a wide range of audiences, with less privacy concerns.

In some examples, the visual type 108 may determine how the visual image(s) (captions) may be presented for viewing. In some examples, visual images may be presented in multiple ways, ranging from the abstract to the concrete. For example, the term Disneyland may be visualized as any one or any combination of a still photo of Disneyland, an interactive 3D) map of Disneyland, a video of people riding a roller-coaster, an image of the user in Disneyland, or a list of reviews for Disneyland. While visuals may have similar meaning, they can evoke different levels of attention and provide distinct detail. The trained language model 391 or the trained language model 102 may be trained to prioritize the visual image (caption) that may be most helpful and appropriate in the current context. Some examples of visual types may be a photo (e.g., when the input text states let's go to golden gate bridge), an emoji (e.g., when the input text states “I am so happy today!”), a clip art or line drawing (e.g. when the input text inquiries about a simple illustration), a map (e.g., when listening to a tour guide state that “LA is located in north California”), a list (e.g., a list of recommended restaurants when the input text states “what shall we have for dinner?”), a movie poster (e.g., when the input text states “let's watch Star Wars tonight”), a personal photo from album/contact (e.g., when the input text states “Lucy is coming to our home tonight”), a 3D model (e.g., when the input text states “how large is a bobcat?”) to visualize a true-size bobcat in the first computing device 200A, for example an AR glasses, an equation (e.g., when the input text states “what is the Newton Law?”), an article (e.g., retrieve the first page of the paper from Google Scholar when the input text states “What's the Kinect Fusion paper published in UIST 2020?”), and/or a Uniform Resource Locator (URL) for a website (e.g., visualize the thumbnail of a go link, when the input text mentions a web page).

In some examples, the confidence scores 109 for the visual images (captions) may indicate the probability whether the user may prefer to display the suggested visual image (caption) or not and/or whether the visual images (captions) may enhance the communication or not. In some examples, the confidence score may be from 0-1. In some examples a visual image (caption) may only be displayed when the confidence score is greater than a threshold confidence score of 0.5. For example, a user may not prefer a personal image from a private album to be displayed at a business meeting. Thus, the confidence score of such an image in a business meeting may be low, e.g., 0.2.

In operation 460, one or more images are selected for visualization based on visual content 106, visual source 107, visual type 108, and confidence scores 109 for the visual images (captions) suggested by the trained language model 391 or the trained language model 102. In some examples, visual content 106, visual source 107, visual type 108, and confidence scores 109 for the visual images (captions) are transmitted from the external device 290 to the computing device 300 (200A, 200B, 200C, 200D, 200E, and/or 200F) as described in the examples above, or another computing device having processing and display capability. In some examples, a relatively small ML model 365 is executed on the computing device 300 (200A, 200B, 200C, 200D, 200E, and/or 200F) as described in the examples above, or another computing device having processing and display capability to identify the images to be displayed based on visual content 106, visual source 107, visual type 108, and confidence scores 109 for the visual images (captions) suggested by the trained language model 391 or the trained language model 102.

In some examples, the processor 350 of the computing device 300 (200A, 200B, 200C, 200D, 200E, and/or 200F) as described in the examples above, may assign a numerical score to each of the type of the visual images, the source of the visual images, the content of the visual images, and the confidence score for each of the visual images. In some examples, the images to be displayed are identified based on a weighted sum of the score assigned to each of the type of the visual images, the source of the visual images, the content of the visual images, and the confidence score for each of the visual images.

In some examples, a relatively small ML model 392 is executed on the external device 290 to identify the images to be displayed based on visual content 106, visual source 107, visual type 108, and confidence scores 109 for the visual images (captions) suggested by the trained language model 391 or the trained language model 102. The identified visual images (captions) may be transmitted from the external device 290 to the computing device 300 (200A, 200B, 200C, 200D, 200E, and/or 200F) as described in the examples above, or another computing device having processing and display capability.

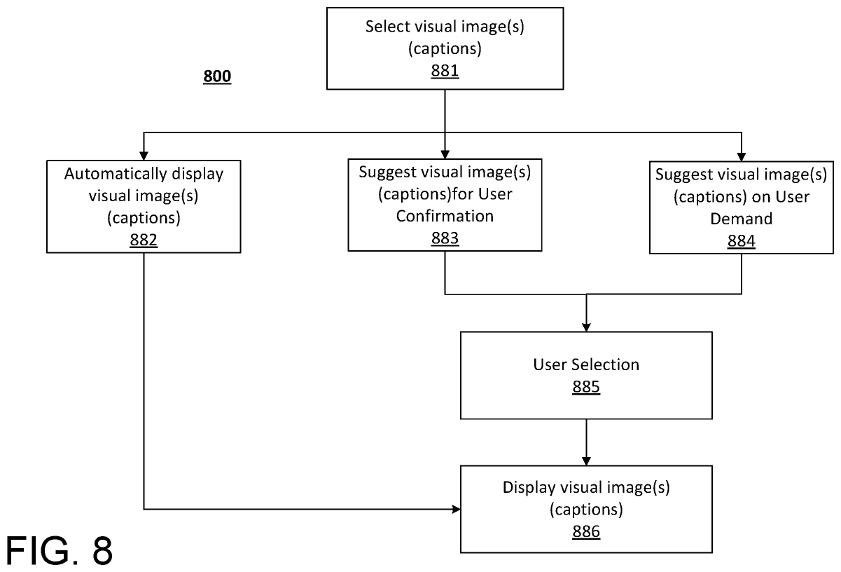

In operation 470, the at least one processor 350 of the computing device 300 (200A, 200B, 200C, 200D, 200E, and/or 200F) as described in the examples above, or another computing device having processing and display capability may visualize the identified images (captions). Further details regarding the visualization of the visual images (captions) are described below with reference to FIG. 8 below.

In some examples, the identifying of the one or more visual images (captions) may be based on a weighted sum of a score assigned to each of the type of the visual images, the source of the visual images, the content of the visual images, and the confidence score for each of the visual images.

In some examples, a cumulative confidence score Se may be determined based on a combination of confidence score 109 inferred by the trained language model 391 or the trained language model 102 (illustrated in FIGS. 1A-1B) and a confidence score Δ109 inferred by a relatively small ML model 365 that is executed on the computing device 300 (200A, 200B, 200C, 200D, 200E, and/or 200F) as described in the examples above. The relatively small ML model 365 is executed on the computing device 300 (200A, 200B, 200C, 200D, 200E, and/or 200F) to identify the images to be displayed for the user as described above. The confidence score Δ109 may be obtained from the relatively small ML model 365 disposed on the computing device 300 when live data is provided as an input to identify the one or more visual images (captions) 120 for visualization. The confidence score Δ109 may be used to fine tune the ML model 365 or to minimize a loss function. Thus, the confidence score 109 may be fine-tuned based on the performance of the ML model disposed on the user's computing device and privacy of the user data is maintained at the computing device 300 as user identifiable data is not used to fine-tune the trained language model 391 or the trained language model 102 (illustrated in FIGS. 1A-1B).

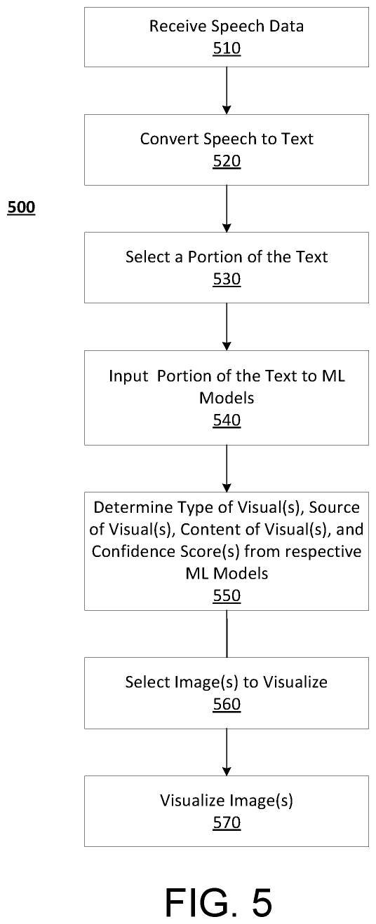

FIG. 5 is a diagram illustrating an example of a method 500 for providing visual captions to facilitate a conversation, video conferencing, and/or presentation, in accordance with implementations described herein. The method may be implemented by a computing device having processing, image capture, display capability, and access to information related to the audio data generated during any one or any combination of conversation, video conferencing, and/or presentation. In the example of FIG. 5, the systems and methods are conducted via the first computing device 200A or the sixth computing device 200F as described in the examples above, simply for purposes of discussion and illustration. The principles to be described herein can be applied to the use of other types of computing devices for the automated generation and display of real-time video captions, such as for example, computing device 300 (200B, 200C, 200D, and/or 200E) as described in the examples above, or another computing device having processing and display capability. Although FIG. 5 illustrates an example of operations in sequential order, it will be appreciated that this is merely an example, and that additional or alternative operations may be included. Further, the operations of FIG. 5 and related operations may be executed in a different order than that shown, or in a parallel or overlapping fashion. Descriptions of many of the operations of FIG. 4 are applicable to similar operations of FIG. 5, thus these descriptions of FIG. 4 are incorporated herein by reference, and may not be repeated for brevity.

Operations 410, 420, 430, 460, and 470 of FIG. 4 are similar to operations 510, 520, 530, 560, and 570 of FIG. 5, respectively. Thus, the description of operation 410, 420, 430, 460, and 470 of FIG. 4 are applicable to the operations 510, 520, 530, 560, and 570 of FIG. 5 and may not be repeated. Moreover, some of the description of the remaining operation of FIG. 4, operations 440 and 450, are also applicable to FIG. 5 and are incorporated herein for brevity.

In operation 540, a portion of the transcribed text is input in one or more relatively small ML model 392 that is executed on the external device 290. The one or more ML model 392 identifies visual image(s) (captions) to be displayed on the computing devices 300 (for example, the first computing device 200A or the sixth computing device 200F as described in the examples above, or another computing device having processing and display capability). In some examples, the one or more ML model 392 may comprise four ML models 392. In some examples, each of the four ML models 392 may output one of a type of visual images to be provided to the users, a source of the visual images that is to be provided, a content of the visual images, and a confidence score for each of the visual images.

In operation 550, in response to the input text, the four small ML models 392 may be optimized (trained) to consider the context of the speech and to predict some of the user's visual intent. In some examples, the prediction of the user's visual intent may include predicting visual content 106, visual source 107, visual type 108, and confidence scores 109 for the visual images (captions) by each one of the small ML model 392, respectively.

In some examples, the four ML models may be disposed on the computing device 300 (200A, 200B, 200C, 200D, 200E, and/or 200F) as ML models 365. One or more the microcontrollers 355 are configured to execute a ML model 365, respectively to perform an inference operation and to output one of a type of visual images to be provided to the users, a source of the visual images that is to be provided, a content of the visual images, and a confidence score for each of the visual images.

The remainder of the description of operations 440 and 450 that do not contradict the disclosure of operations 540 and 550 are also applicable to operations 540 and 550, and are incorporated herein by reference. These descriptions may not be repeated here.

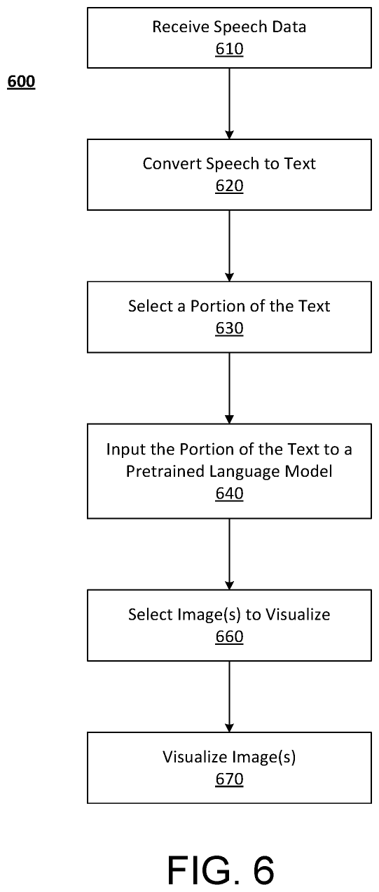

FIG. 6 is a diagram illustrating an example of a method 600 for providing visual captions to facilitate a conversation, video conferencing, and/or presentation, in accordance with implementations described herein. The method may be implemented by a computing device having processing, image capture, display capability, and access to information related to the audio data generated during any one or any combination of conversation, video conferencing, and/or presentation. In the example of FIG. 6, the systems and methods are conducted via the first computing device 200A or the sixth computing device 200F as described in the examples above, simply for purposes of discussion and illustration. The principles to be described herein can be applied to the use of other types of computing devices for the automated generation and display of real-time video captions, such as for example, computing device 300 (200B, 200C, 200D, and/or 200E) as described in the examples above, or another computing device having processing and display capability. Although FIG. 6 illustrates an example of operations in sequential order, it will be appreciated that this is merely an example, and that additional or alternative operations may be included. Further, the operations of FIG. 6 and related operations may be executed in a different order than that shown, or in a parallel or overlapping fashion. Descriptions of many of the operations of FIG. 4 are applicable to similar operations of FIG. 6, thus these descriptions of FIG. 4 are incorporated herein by reference, and may not be repeated for brevity.

Operations 410, 420, 430, 460, and 470 of FIG. 4 are similar to operations 610, 620, 630, 660, and 670 of FIG. 6, respectively. Thus, the description of operation 410, 420, 430, 460, and 470 of FIG. 4 are applicable to the operations 610, 620, 630, 660, and 670 of FIG. 6 and may not be repeated. Moreover, some of the descriptions of the remaining operation of FIG. 4, operations 440 and 450, are also applicable to FIG. 5 and are incorporated herein for brevity.

In operation 640, a portion of the transcribed text is input into a trained language model that identifies image(s) to be displayed on the computing devices 300 (for example, the first computing device 200A or the sixth computing device 200F as described in the examples above, or another computing device having processing and display capability). In some examples, the trained language model 391 may accept a text string as an input and output one or more visual images (captions) corresponding to the text string. In some examples, visual images (captions) may be based on the visual intent corresponding to visual images that participants in a conversation may desire to display, and the visual intent may suggest relevant visual images to be displayed during the conversation, which facilitates and enhances the communication. The trained language model 391 may be optimized to consider the context of the conversation, and to infer a type of visual images to be provided to the users, a source of the visual images that is to be provided, a content of the visual images, and a confidence score for each of the visual images to suggest the visual images (captions) for display.

The remainder of the description of operations 440 and 450 that do not contradict the disclosure of operations 540 and 550 are also applicable to operations 540 and 550, and are incorporated herein by reference. These descriptions may not be repeated here.

FIG. 7 is a diagram illustrating an example of a method 700 for selecting a portion of the transcribed text in accordance with implementations described herein. The method may be implemented by a computing device having processing, control capability, and access to information related to the audio data generated during any one or any combination of conversation, video conferencing, and/or presentation. In the example of FIG. 7, the systems and methods are conducted via the first computing device 200A or the sixth computing device 200F as described in the examples above, simply for purposes of discussion and illustration. In some examples, the first computing device 200A or the sixth computing device 200F as described in the examples above may stream the text data to the external resources 390 or the additional resources over the wireless connection 306.

In some examples, the first computing device 200A, the sixth computing device 200F, or the computing device 300 as described in the examples above may execute the one or more applications 360, stored in the memory devices 330, and that, when executed by the processor(s) 350, perform text editing operations. In some examples, a portion of the text is extracted by the text editing operation and provided as an input to the trained language model 391. In an example, the control system 370 may be configured to control the processor 350 to execute software code to perform the text editing operations. In operation 710, the processor 350 may execute one or more applications 360 to commence the operation of selecting a portion of the translated text. In operation 711, the processor 350 may execute one or more applications 360 to retrieve the entire text of the last spoken sentence. In operation 712, the processor 350 may execute one or more applications 360 to retrieve the entire text of the last two spoken sentences. In some examples, an end of sentence punctuation, such as “.”, “?”, or “!” may signify the sentence being complete. In operation 713, the processor 350 may execute one or more applications 360 to retrieve the at least the last nₘᵢₙ spoken words, where last nₘᵢₙ is the number of words in the text string that may be extracted from the end of the text string. In some examples, nₘᵢₙ is a natural number greater than 4. The end of the text string signifying the last spoken words that were translated to text.

FIG. 8 is a diagram illustrating an example of a method 800 for visualizing the visual captions or images to be displayed in accordance with implementations described herein. In some examples, the visual images (captions) are private, i.e., the visual images (captions) are only presented to the speaker and are invisible to any audience that may be present. In some examples, the visual images (captions) are public, i.e., the visual images (captions) are presented to everyone in the conversation. In some examples, the visual images (captions) are semi-public, i.e., the visual images (captions) may be selectively presented to a subset of audiences. In an example, the user may share the visual images (captions) with partners from the same team during a debate or competition. As described below, in some examples, users may be provided the option of privately previewing the visual images (captions) before displaying them to the audiences.

Based on the output of the trained language model 391 and/or the one or more ML model 392 and/or 365, the visual captions may be displayed using one of three different modes: on-demand-suggest, auto-suggest, and auto-display. In operation 881, the processor 350 may execute one or more applications 360 to commence the operation of displaying the visual images (captions) on a display of the computing devices 300 (for example, the first computing device 200A or the sixth computing device 200F as described in the examples above, or another computing device having processing and display capability). The principles to be described herein can be applied to the use of other types of computing devices for the automated generation and display of real-time image captions, such as for example, computing device 300 (200B, 200C, 200D, and/or 200E) as described in the examples above, or another computing device having processing and display capability. In operation 882, the processor 350 may execute one or more applications 360 to enable the auto-display mode where the visual images (captions) inferred by the trained language model 391 and/or the one or more ML model 392 and/or 365 are autonomously added to the display. This operation may also be referred to as auto-display mode. In an example, when visual images (captions) and/or an emoji are generated in the auto-display mode, the computing device 300 autonomously searches and displays visuals publicly to all meeting participants and no user interaction is needed. In auto display mode, the scrolling view is disabled.

In operation 883, the processor 350 may execute one or more applications 360 to enable the auto-suggest mode where the visual images (captions) inferred by the trained language model 391 and/or the one or more ML models 392 and/or 365 are suggested to the user. In some examples, this mode of display may also be referred to as proactively recommending visual images (captions). In some examples, in the auto-suggest mode, the suggested visuals will be shown in a scrolling view that is private to the user. A user input may be needed to display visual images (captions) publicly.

In operation 885, the user may indicate a selection of one or more of the suggested visual images (captions). This operation may also be referred to as auto-suggest mode. In operation 886, based on the user selecting the one or more of the recommended visual images (captions), the selected visual images (captions) may be added to the conversation to enhance the conversation. In some examples, the visual images (captions) may be selectively shown to a subset of all the participants in the conversation.

In operation 884, the processor 350 may execute one or more applications 360 to enable the on-demand-suggest mode where the visual images (captions) inferred by the trained language model 391 and/or the one or more ML models 392 and/or 365 are suggested to the user. In some examples, this mode may also be referred to as proactively recommending visual images (captions). In operation 885, the user may indicate a selection of one or more of the suggested visual images (captions). This operation may also be referred to as on-demand mode.

In operation 885, in some examples, the user selection may be recognized by the computing device 300 (200A, 200B, 200C, 200D, 200E, and/or 200F) based on audio input device that can detect user audio inputs, a gesture input device that can detect user gesture inputs (i.e., via image detection, via position detection and the like), a pose input device that can detect a body pose of the user, such as waving hands (i.e., via image detection, via position detection and the like), gaze tracking device that may detect and track eye gaze direction and movement (i.e., a user input may be triggered in response to a gaze being directed at the visual image for greater than or equal to a threshold duration/preset amount of time), traditional input devices (i.e., a controller conferred to recognize keyboard, mouse, touch screens, space bar, and laser pointer), and/or such devices configured to capture and recognize an interaction with the user.

In operation 886, the visual images (captions) may be added to the conversation to enhance the conversation. In some examples, the visual images (captions) may be selectively shown to a subset of the participants in the conversation. Further details regarding the display of the visual images in operations 885 and 886 are provided with reference to FIGS. 9A-9B below.

FIGS. 9A-9B are diagrams illustrating example options for the selection, determination, and display of visual images (captions) to enhance person-to-person communication, video conferencing, podcast, presentation, or other forms of internet-based communication in accordance with implementations described herein.

As illustrated in FIGS. 9A-9B, the visual images (captions) settings page menu may facilitate the customization of a variety of settings including levels of the proactivity of the suggestion provided by the pretrained language model and the ML models, whether to suggest emoji or personal images in the visual images (captions), punctuality of visual suggestions, visual suggestion models that may be used, the maximum number of visual images (captions) and/or emojis that may be displayed, etc.

FIG. 9A illustrates an example of visual images (captions) settings page menu, which allows the user to selectively customize a variety of settings to operate the visual images (captions) generating system. FIG. 9B illustrates another example of visual images (captions) settings page menu, which allows the user to selectively customize a variety of settings to operate the visual images (captions) generating system. In both the visual images (captions) settings page menu shown in FIGS. 9A and 9B, the visual captions are enabled. In both the visual images (captions) settings page menu shown in FIGS. 9A and 9B, the setting has been set for the trained language model 391 to process the entire input text of the last complete sentence to provide the visual intents. In both the visual images (captions) settings page menu shown in FIGS. 9A and 9B, the minimum number of words that are processed by the trained language model 391 is set to 29, i.e., last nₘᵢₙ words=20.

FIG. 9A illustrates that visual images (captions) may be provided from a user's personal data and emojis may be used. FIG. 9A further illustrates that a maximum of 5 visual images (captions) may be shown in the scrolling view for images, a maximum of 4 emojis may be shown in the scrolling view for emojis, and the visual size may be 1. In an example, the visual size may indicate the number of visual images (captions) or emojis that can be publicly shared at one time. The operation of the scrolling view for the visual images (captions) and emojis are described with reference to FIGS. 1A-1B. FIG. 9B illustrates that visual images (captions) may not be provided from a user's personal data, and all the participants in the conversation may view the visual images (captions) and/or emojis.

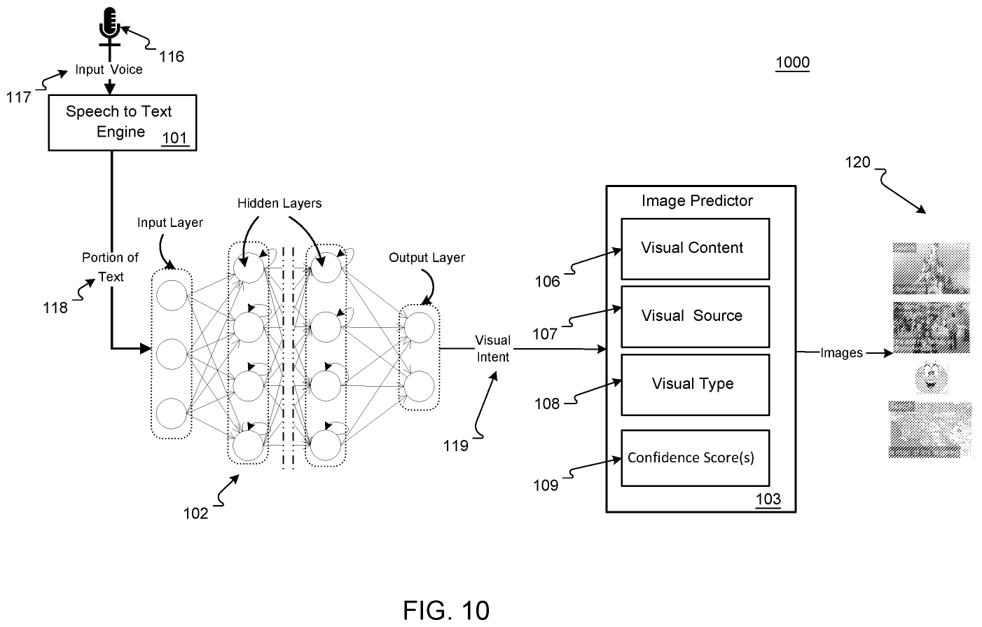

FIG. 10 is a diagram illustrating an example of a process flow for providing visual captions 1000, in accordance with implementations described herein. The method and systems of FIG. 10 may be implemented by a computing device having processing, image capture, display capability, and access to information related to the audio data generated during any one or any combination of conversation, video conferencing, and/or presentation. In the example of FIG. 10, the systems and methods are conducted via the first computing device 200A or the sixth computing device 200F as described in the examples above, simply for purposes of discussion and illustration. The principles to be described herein can be applied to the use of other types of computing devices for the automated generation and display of real-time image captions, such as for example, computing device 300 (200B, 200C, 200D, and/or 200E) as described in the examples above, or another computing device having processing and display capability. Although FIG. 10 illustrates an example of operations in sequential order, it will be appreciated that this is merely an example, and that additional or alternative operations may be included. Further, the operations of FIG. 10 and related operations may be executed in a different order than that shown, or in a parallel or overlapping fashion. Descriptions of many of the operations of FIG. 4 are applicable to similar operations of FIG. 10, thus these descriptions of FIG. 4 are incorporated herein by reference, and may not be repeated for brevity.

As shown in FIG. 10, at least one processor 350 of the computing device (for example, the first computing device 200A or the sixth computing device 200F as described in the examples above, or another computing device having processing and image capture capability) may activate one or more audio input device 116 (for example, a microphone) to capture audio 117 being spoken.

Based on the audio sensor data received, the computing device (for example, the first computing device 200A or the sixth computing device 200F as described in the examples above, or another computing device having processing and display capability) may generate textual representation of the speech/voice. In some examples, the microcontroller 355 is configured to generate a textual representation of the speech/voice by executing an application 360 or a ML model 365. In some examples, the first computing device 200A or the sixth computing device 200F as described in the examples above may stream the audio data (e.g., raw sound, compressed sound, sound snippet, extracted features, and/or audio parameters, etc.) to the external resources 390 over the wireless connection 306. In some examples, the transcription engine 101 of the external resources 390 may provide for transcription of the received speech/voice into text.

The at least one processor 350 of the computing device (for example, the first computing device 200A or the sixth computing device 200F as described in the examples above, or another computing device having processing and image capture capability) may extract a portion of the transcribed text 118.

A portion of the transcribed text 118 is input into a trained language model 102 that identifies image(s) to be displayed on the computing devices 300 (for example, the first computing device 200A or the sixth computing device 200F as described in the examples above, or another computing device having processing and display capability). In some examples, the trained language model 102 is executed on a device external to the computing devices 300. In some examples, the trained language model 102 may accept a text string as an input and output one or more visual intents 119 corresponding to the text string. In some examples, the visual intent corresponds to visual images that participants in a conversation may desire to display, and the visual intent may suggest relevant visual images to be displayed during the conversation, which facilitates and enhances the communication. The trained language model 102 may be optimized to consider the context of the conversation, and to infer a content of the visual images, a source of the visual images that is to be provided, a type of visual images to be provided to the users, and a confidence score for each of the visual images, i.e., the visual content 106, the visual source 107, visual type 108, and the confidence score 109 for each of the visual images.

An image predictor 103 may predict one or more visual images (captions) 120 for visualization based on visual content 106, visual source 107, visual type 108, and confidence scores 109 for the visual images (captions) suggested by the trained language model 391 or the trained language model 102. In some examples, visual content 106, visual source 107, visual type 108, and confidence scores 109 for the visual images (captions) are transmitted from the trained language model 102 to the computing device 300 (200A, 200B, 200C, 200D, 200E, and/or 200F) as described in the examples above, or another computing device having processing and display capability. In some examples, the image predictor 103 is a relatively small ML model 365 that is executed on the computing device 300 (200A, 200B, 200C, 200D, 200E, and/or 200F) as described in the examples above, or another computing device having processing and display capability to identify the visual images (captions) 120 to be displayed based on visual content 106, visual source 107, visual type 108, and confidence scores 109 for the visual images (captions) suggested by the trained language model 102.

The at least one processor 350 of the computing device 300 (200A, 200B, 200C, 200D, 200E, and/or 200F) as described in the examples above, or another computing device having processing and display capability may visualize the identified visual images (captions) 120.

The remainder of the description of FIG. 4 that does not contradict the disclosure of FIG. 10 are also applicable to FIG. 10, and are incorporated herein by reference. These descriptions may not be repeated here.

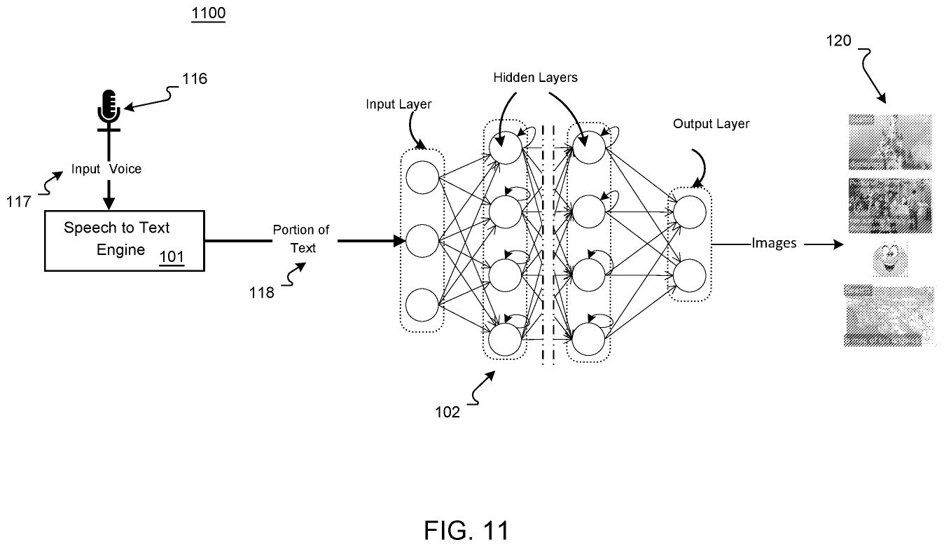

FIG. 11 is a diagram illustrating an example of a process flow for providing visual captions 1100, in accordance with implementations described herein. The method and system of FIG. 11 may be implemented by a computing device having processing, image capture, display capability, and access to information related to the audio data generated during any one or any combination of conversation, video conferencing, and/or presentation. In the example of FIG. 11, the systems and methods are conducted via the first computing device 200A or the sixth computing device 200F as described in the examples above, simply for purposes of discussion and illustration. The principles to be described herein can be applied to the use of other types of computing devices for the automated generation and display of real-time video captions, such as for example, computing device 300 (200B, 200C, 200D, and/or 200E) as described in the examples above, or another computing device having processing and display capability. Although FIG. 11 illustrates an example of operations in sequential order, it will be appreciated that this is merely an example, and that additional or alternative operations may be included. Further, the operations of FIG. 11 and related operations may be executed in a different order than that shown, or in a parallel or overlapping fashion. Descriptions of many of the operations of FIG. 6 are applicable to similar operations of FIG. 11, thus these descriptions of FIG. 6 are incorporated herein by reference, and may not be repeated for brevity.

As shown in FIG. 11, at least one processor 350 of the computing device (for example, the first computing device 200A or the sixth computing device 200F as described in the examples above, or another computing device having processing and image capture capability) may activate one or more audio input device 116 (for example, a microphone) to capture audio 117 being spoken.

Based on the audio sensor data received, the computing device (for example, the first computing device 200A or the sixth computing device 200F as described in the examples above, or another computing device having processing and display capability) may generate textual representation of the speech/voice. In some examples, the microcontroller 355 is configured to generate a textual representation of the speech/voice by executing an application 360 or a ML model 365. In some examples, the first computing device 200A or the sixth computing device 200F as described in the examples above may stream the audio data (e.g., raw sound, compressed sound, sound snippet, extracted features, and/or audio parameters, etc.) to the external resources 390 over the wireless connection 306. In some examples, the transcription engine 101 of the external resources 390 may provide for transcription of the received speech/voice into text.

The at least one processor 350 of the computing device (for example, the first computing device 200A or the sixth computing device 200F as described in the examples above, or another computing device having processing and image capture capability) may extract a portion of the transcribed text 118.

A portion of the transcribed text 118 is input into a trained language model 102 that identifies image(s) to be displayed on the computing devices 300 (for example, the first computing device 200A or the sixth computing device 200F as described in the examples above, or another computing device having processing and display capability). In some examples, the trained language model 102 may accept a text string as an input and output one or more visual images (captions) corresponding to the text string. In some examples, visual images (captions) may be based on the visual intent corresponding to visual images that participants in a conversation may desire to display, and the visual intent may suggest relevant visual images to be displayed during the conversation, which facilitates and enhances the communication. The trained language model 391 may be optimized to consider the context of the conversation, and to infer a type of visual images to be provided to the users, a source of the visual images that is to be provided, a content of the visual images, and a confidence score for each of the visual images to suggest the visual images (captions) for display.

A portion of the transcribed text 118 is input into a trained language model 102 that identifies image(s) to be displayed on the computing devices 300 (for example, the first computing device 200A or the sixth computing device 200F as described in the examples above, or another computing device having processing and display capability). In some examples, the trained language model 102 is executed on a device external to the computing devices 300. In some examples, the trained language model 102 may accept a text string as an input and output one or more visual intents 119 corresponding to the text string. In some examples, the visual intent corresponds to visual images that participants in a conversation may desire to display, and the visual intent may suggest relevant visual images to be displayed during the conversation, which facilitates and enhances the communication. The trained language model 102 may be optimized to consider the context of the conversation, and to infer a content of the visual images, a source of the visual images that is to be provided, a type of visual images to be provided to the users, and a confidence score for each of the visual images, i.e., the visual content 106, the visual source 107, visual type 108, and the confidence score 109 for each of the visual images.

The at least one processor 350 of the computing device 300 (200A, 200B, 200C, 200D, 200E, and/or 200F) as described in the examples above, or another computing device having processing and display capability may visualize the identified visual images (captions) 120.

The remainder of the description of FIG. 6 that does not contradict the disclosure of FIG. 11 are also applicable to FIG. 11, and are incorporated herein by reference. These descriptions may not be repeated here.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computer-implemented method, comprising:
receiving audio data via a sensor of a computing device;
converting the audio data to a text and extracting a portion of the text;
inputting the portion of the text to a neural network-based language model to obtain at least one of a type of visual images, a source of the visual images, a content of the visual images, or a confidence score for each of the visual images;
determining at least one visual image based on at least one of the type of the visual images, the source of the visual images, the content of the visual images, or the confidence score for each of the visual images; and
outputting the at least one visual image on a display of the computing device.

2. The method of claim 1, wherein the computing device is a head mounted smart glasses.

3. The method of claim 1, wherein the computing device is a smart display configured for video conferencing.

4. The method of claim 2, further comprising a smart phone in communication with the head mounted smart glasses and the neural network-based language model being disposed on the smart phone.

5. The method of claim 1, further comprising an external computing device in communication with the computing device and the neural network-based language model being disposed on the external computing device.

6. The method of claim 5, further comprising:
transmitting the portion of the text to the external computing device;
receiving, at the computing device, the type of the visual images, the source of the visual images, the content of the visual images, and the confidence score for each of the visual images from the external computing device; and
inputting the type of the visual images, the source of the visual images, the content of the visual images, and the confidence score for each of the visual images to a machine learning (ML) model to determine the at least one visual image.

7. The method of claim 1, wherein the determining of the at least one visual image comprises determining the at least one visual image based on a weighted sum of a score assigned to each of the type of the visual images, the source of the visual images, the content of the visual images, and the confidence score for each of the visual images.

8. The method of claim 1, wherein the confidence score for each of the visual images is between 0 and 1, and the method further comprises:
omitting the outputting of a visual image, in response to the respective confidence score of the visual image not meeting a threshold confidence score of 0.5.

9. The method of claim 1, wherein the type of the visual images comprises at least one of a photo stored on the computing device, an emoji, an image, a video, a map, a personal photo from an album or a contact, a three dimensional (3D) model, a clip art, a poster, a visual representation of a Uniform Resource Locator (URL) for a website, a list, an equation, or an article.

10. The method of claim 1, wherein the portion of the text comprises at least a number of words from an end of the text greater than a threshold.

11. The method of claim 1, wherein the outputting of the at least one visual image comprises outputting the at least one visual image as a scrollable list proximate to a side of the display of the computing device.

12. The method of claim 11, further comprising outputting the at least one visual image as a vertical scrollable list.

13. The method of claim 11, further comprising outputting the at least one visual image as a horizontal scrollable list, in response to the at least one visual image being an emoji.

14. The method of claim 11, further comprising publicly displaying an image from the scrollable list, in response to an input being received form a user of the computing device.

15. The method of claim 14, wherein the input from the user comprises a duration of a gaze directed to the image in the scrollable list being greater than a threshold amount of time.

16. The method of claim 11, wherein:
the scrollable list is displayed on the computing device and not visible to another computing device in communication with the computing device; and
the scrollable list is displayed on the another computing device, in response to an input being received from a user of the computing device.

17. A computing device, comprising:
at least one processor; and
a memory storing instructions that, when executed by the at least one processor, configures the at least one processor to:
receive audio data via a sensor of the computing device;
convert the audio data to a text and extract a portion of the text;
input the portion of the text to a neural network-based language model to obtain at least one of a type of visual images, a source of the visual images, a content of the visual images, or a confidence score for each of the visual images;
determine at least one visual image based on the type of the visual images, the source of the visual images, the content of the visual images, or the confidence score for each of the visual images; and
output the at least one visual image on a display of the computing device.

18. The computing device of claim 17, wherein the at least one processor is further configured to:
transmit the portion of the text to an external computing device in communication with the computing device;
receive, at the computing device, the type of the visual images, the source of the visual images, the content of the visual images, and the confidence score for each of the visual images from the external computing device; and
input the type of the visual images, the source of the visual images, the content of the visual images, and the confidence score for each of the visual images to a machine learning (ML) model to determine the at least one visual image.

19. The computing device of claim 17, wherein the at least one processor is further configured to determine the at least one visual image based on a weighted sum of a score assigned to each of the type of the visual images, the source of the visual images, the content of the visual images, and the confidence score for each of the visual images.

20. A computer-implemented method for providing visual captions, the method comprising:
receiving audio data via a sensor of a computing device;
converting the audio data to text and extracting a portion of the text;
inputting the portion of the text to one or more machine language (ML) models to obtain at least one of a type of visual images, a source of the visual images, a content of the visual images, or a confidence score for each of the visual images from respective ML model of the one or more ML models;
determining at least one visual image by inputting at least one of the type of the visual images, the source of the visual images, the content of the visual images, and the confidence score for each of the visual images to another ML model; and
outputting the at least one visual image on a display of the computing device.
